(19) United States
(12) Patent Application Publication
(10) Pub. No.: US 2016/0329860 A1
(43) Pub. Date: Nov. 10, 2016

(54) SOLAR TRACKING APPARATUS

(71) Applicant: SunPower Corporation, San Jose, CA (US)

(72) Inventors: Jason KALUS, Redwood City, CA (US); Mark SCHIMELPFENIG, Hayward, CA (US); Richard ERB, San Francisco, CA (US); Tamir LANCE, Los Gatos, CA (US); Nathan BECKETT, Oakland, CA (US)

(21) Appl. No.: 15/146,443

(22) Filed: May 4, 2016

Related U.S. Application Data
(60) Provisional application No. 62/156,782, filed on May 4, 2015.
(60) Provisional application No. 62/204,717, filed on Aug. 13, 2015.

(51) Int. Cl. H02S 20/32; H02S 30/10; H02S 20/10

(52) U.S. Cl. CPC H02S 20/32; H02S 20/10; H02S 30/10

(57) ABSTRACT

A variety of techniques may be employed alone or in various combinations, to track alignment of solar collectors with movement of the sun. One approach utilizes two or more piles offset from a single axis of tracking rotation, to provide foundational support. By allocating support between multiple foundational piles, such embodiments reduce the size of any individual pile needed to withstand accumulated torque from sources such as wind. Another approach utilizes an attachment feature to attach a panel to an underlying support arm. The attachment feature may be glued to a bottom surface of a collector panel, and locked into place on the support arm using sliders. Another approach focuses upon the arm structure itself, and the manner of its attachment to a torque tube of a single-axis tracker. Other approaches relate to techniques for stowing solar trackers, and field layout designs for solar trackers.

### CROSS REFERENCE TO RELATED APPLICATIONS

This application claims benefit of priority to U.S. Provisional Application No. 62/156,782 titled “Solar Tracking Apparatus” filed May 4, 2015 and to U.S. Provisional Application No. 62/204,717 titled “Solar Tracking Apparatus” filed Aug. 13, 2015, both of which are incorporated herein by reference in their entirety.

### FIELD OF THE INVENTION

The invention relates generally to solar trackers that change the orientation of solar panels or other solar energy collectors to track the movement of the sun.

### BACKGROUND

Alternate sources of energy are needed to satisfy ever increasing world-wide energy demands. Solar energy resources are sufficient in many geographical regions to satisfy such demands, in part, by provision of electric power generated with solar (e.g., photovoltaic) cells.

### SUMMARY

A variety of techniques may be employed alone or in various combinations, to track solar collectors with the movement of the sun. One approach utilizes two or more piles offset from a single axis of tracking rotation to provide foundational support for a drive mechanism. By allocating support between multiple foundational piles, such embodiments reduce the size of any individual pile needed to withstand accumulated torque from sources such as wind. Another approach utilizes an attachment feature, which may be glued to a bottom surface of the panel, that attaches to an underlying support structure. The attachment feature may be locked into place on the support structure using sliders. Another approach focuses upon the support structure itself, which may comprise truss-like support arms for example, and the manner of its attachment to a torque tube of a single-axis tracker. Other approaches relate to techniques for stowing solar trackers, and/or field layout designs for solar trackers.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

FIG. 1 shows a simplified perspective view of a solar collector actuated by a tracking device according to an embodiment.

FIG. 2 shows an enlarged perspective view of a portion of FIG. 1.

FIG. 3 shows a further enlarged perspective view of a portion of FIG. 2.

FIGS. 4A-D are various simplified views of a foundation for a solar tracking system.

FIGS. 5A-G are various simplified views illustrating a solar panel attachment and mounting approach according to an embodiment.

FIGS. 6A-6F2 are various simplified views illustrating a support assembly for a tracking system according to an embodiment.

FIG. 7 shows various simplified views illustrating tracker stowing approaches according to embodiments.

FIGS. 8A-8B show a simplified view of solar field layout designs.

FIGS. 9A-9F show various views of an alternative embodiment of a drive mechanism.

FIGS. 10A-10K show various views of an alternative embodiment of a panel attachment scheme.

FIGS. 11A-C show views of an alternative embodiment of a torsional locking device.

FIGS. 12A-C show views of an alternative embodiment of a torsional locking device.

FIGS. 13A-B shows alternative embodiments of torsional locking devices.

FIGS. 14A-D show views of an alternative embodiment of a torsional locking device.

FIGS. 15A-E show views of alternative embodiments of a torsional locking device.

FIGS. 16A-B are simplified views showing wind load forces.

FIGS. 17A-E2 show views of a support assembly according to an alternative embodiment.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used in this specification and the appended claims, the singular forms “a,” “an,” and “the” include plural referents unless the context clearly indicates otherwise. Also, the term “parallel” is intended to mean “parallel or substantially parallel” and to encompass minor deviations from parallel geometries rather than to require that any parallel arrangements described herein be exactly parallel. The term “perpendicular” is intended to mean “perpendicular or substantially perpendicular” and to encompass minor deviations from perpendicular geometries rather than to require that any perpendicular arrangement described herein be exactly perpendicular.

A solar collector gathers energy from the sun and converts it to a useful form such as electricity and/or heat. To an observer on the ground, the sun moves through the sky (generally from East to West-EW, but also along the North-South direction) during the day. In order to have as much sunlight as possible impinge upon the collector, a tracking device may be used to change a position of the collector to keep it pointed in the EW azimuth of the sun or at other selected angles for other consideration such as preventing shading from neighbors, stowing from strong wind gusts, or enabling panel cleaning for example.

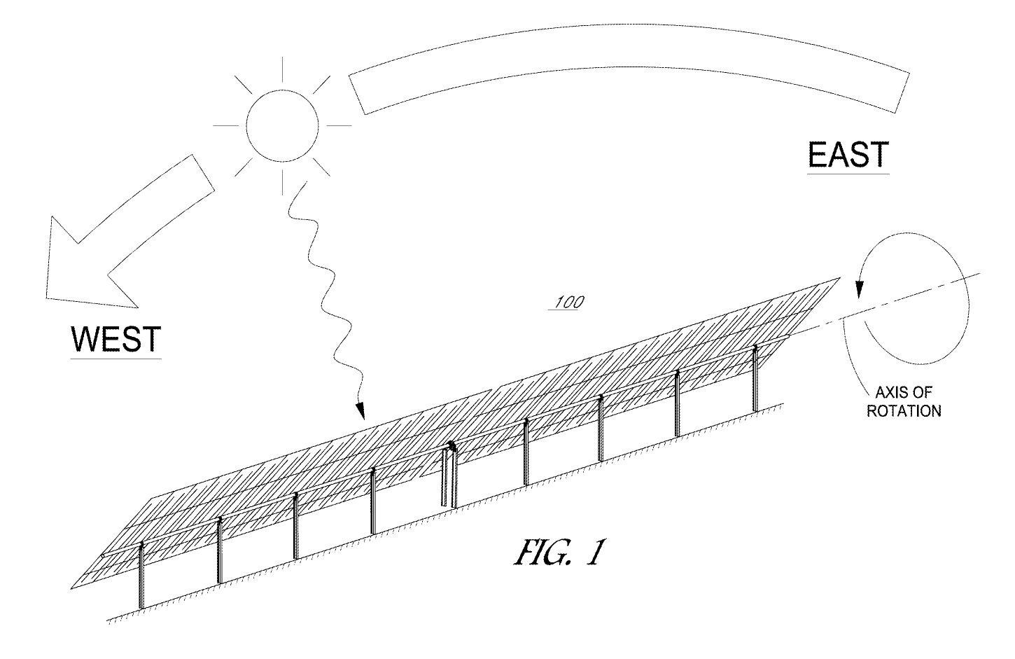

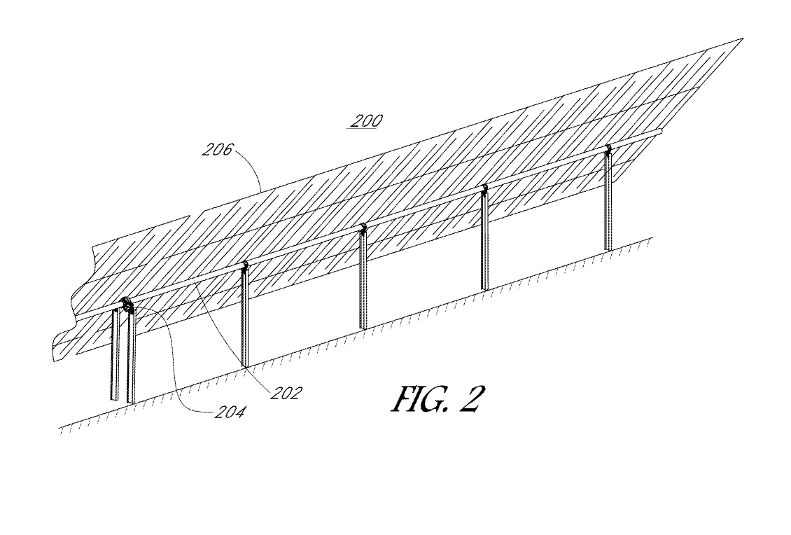

Several types of tracking devices may be used. FIG. 1 shows a simplified view of a one-axis tracking device 100 according to an embodiment. As shown, the axis of the tracker is aligned with the North-South line on the diagram. So, it will gain extra power by rotating from the East to the West over the course of daylight hours. Alternatively, a single-axis tracker may be oriented with its axis aligned along the East-West direction and rotate along the North-South axis over the course of daylight hours.

Other types of tracking apparatuses are known. For example, a two-axis tracker may be designed to track both the EW motion and the NS motion to keep the panels aligned perpendicular to the rays of the sun during operation. Such a tracking approach gains more power, but may tend to add complexity and expense, e.g., using two motors, two sets of gears, and a more complex controller.

One method of reducing the cost of solar tracking apparatuses is to increase the total area of solar panels that are being moved on one tracker. As the area of the tracker is increased, the cost of the structure does not necessarily follow linearly. One of the advantages of the present inventions is that they, in part, enable the tracker to become larger at a minimal cost. These advantages will become more apparent to those skilled in the art when taken with reference to the following more detailed description of the invention

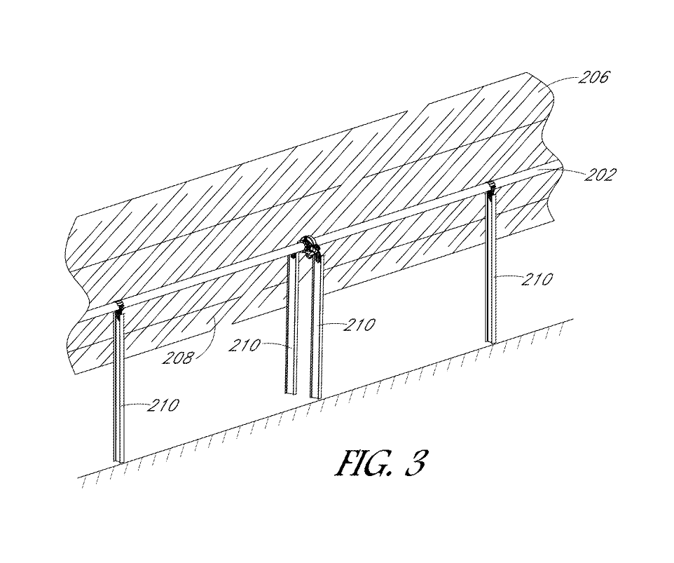

FIG. 2 shows an enlarged view of the single-axis solar collecting and tracking apparatus 200 of FIG. 1. Specifically, a torque tube 202 is a structural member running a length of the system.

The tube 202 is connected to a driving mechanism 204 (e.g., a slew gear driven by a motor) and will turn throughout the day during operation of the tracker. As shown here the driving mechanism may be located at the center of the tube, but this is not required and in other embodiments the driving mechanism may be positioned in other configurations (e.g., for field level reasons and/or logistical purposes).

A one-axis tracker will only rotate around one, long axis.

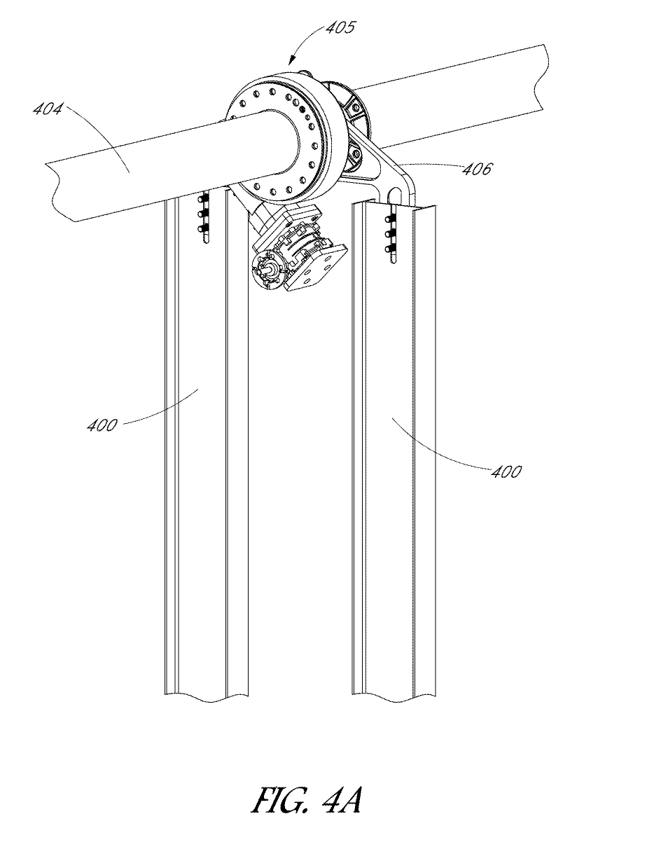

Solar collectors 206 (also referred to herein as solar panels or solar modules) are attached to the tube. Solar collectors 206 typically comprise photovoltaic solar cells, but may in addition or alternatively comprise other solar energy collecting devices. As shown in the further enlarged view offered by FIG. 3, the solar panels are attached to a support structure comprising support arms 208 extending perpendicular to the torque tube 202. As described in detail below, according to some embodiments these support arms can be in the form of a truss.

FIG. 3 also shows that the torque tube is supported by foundations 210. Foundations 201 can be many shapes. As non-limiting examples, they can be piles (e.g., beams) driven into the ground, bolted to a cement block, cast in a cement block, bolted to a large ground screw, or bolted to a large ballast structure. Foundations are discussed further below. A variety of techniques may be employed alone or in various combinations, to track alignment of solar collectors with movement of the sun. One approach utilizes two or more piles offset from a single axis of tracking rotation, to provide foundational support for a drive mechanism. By allocating support between multiple foundational piles, such embodiments reduce the size of any individual pile needed to withstand accumulated torque from sources such as wind. Another approach utilizes an attachment feature to attach a panel to an underlying support structure. The attachment feature may be glued to a bottom surface of a collector panel and, for example, locked into place on a support arm in the support structure using sliders. Another approach focuses upon a support arm structure, and the manner of its attachment to a torque tube of a single-axis tracker. Other approaches relate to tracker stowing techniques, and/or field layout designs for solar trackers.

Solar Tracking System Foundation

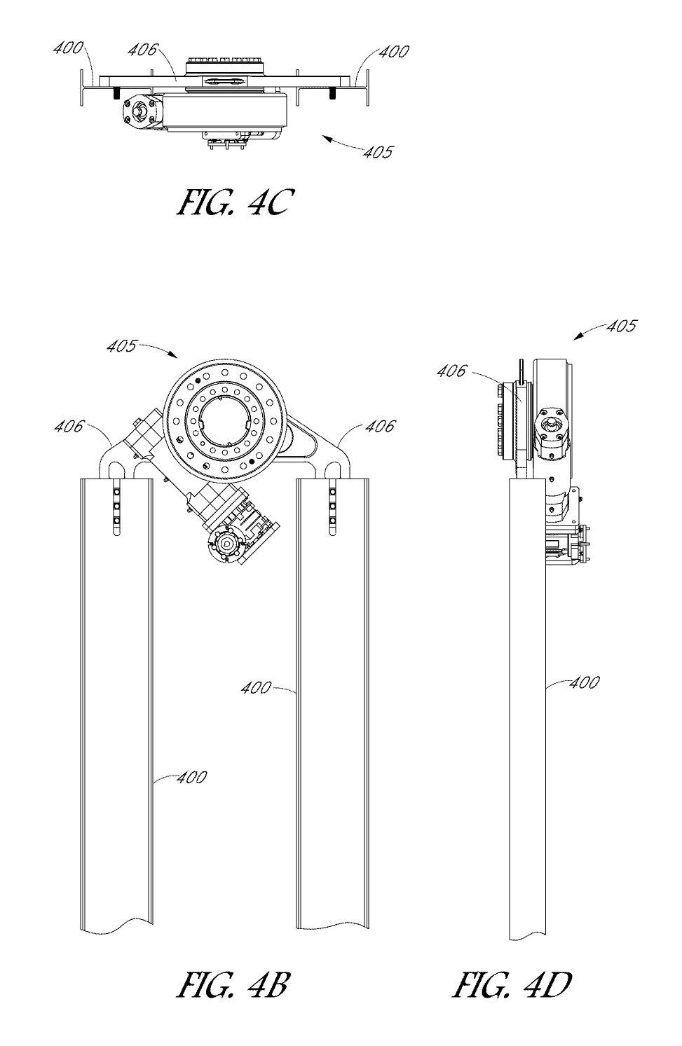

FIGS. 4A-4D are various simplified views illustrating a foundation for a solar tracking system according to an embodiment. As the area of the solar panels on a tracker are increased, the forces and moments from wind gusts that transfer to this pile will also increase. This is especially true as the width of the solar tracker is increased because the magnitude of the moment due to wind gusts will increase by the square of the width.

Accordingly, the particular embodiment of the foundation illustrated in FIG. 4A shows a double pile. This double pile enables the area of solar panels on the tracker to be larger while maintaining an acceptable amount of stress in the beams and still offering low cost installation and manufacturing methods.

In particular, the solar tracking system foundation of FIG. 4A has two piles 400 that are oriented out of line with the others. That is, these piles of the foundation are not located in line with the single axis of rotation of the tracker. Here, torque from the panels along the tube 404, is transferred into the driving mechanism 405. That torque is in turn transferred into a rigid member 406. The rigid member 406 in this embodiment connects each pile with the driving mechanism at the center of rotation. It may be a specially designed casting or a weldment, for example. This is a low cost, easy to install method of creating an otherwise complicated connection between the beams.

From the rigid member, the torque is then allocated between the two piles. This reduces the total load on each member.

FIG. 4B shows a side view of the foundation comprising the two piles supporting the drive mechanism. FIG. 4C shows a simplified top view. FIG. 4D shows an end view.

A solar tracker foundation according to embodiments may exhibit one or more benefits. For example, the torque on the entire apparatus accumulates to the drive location pile. By putting two piles in that location, the load in one pile is reduced. Less stress allows reduction in the size of the individual piles.

When piles are driven into the ground, they use certain equipment that is expensive to mobilize. And, there are limits to the pile sizes able to be driven. Reducing the pile size according to embodiments does not require bigger and more equipment in order to drive the pile. The piles can be the same or similar sizes and lengths. The piles with the driving mechanism can be the same beam size and length as the piles that have a bearing on them to support the rotating tube. This is advantageous for planning and construction purposes

The additional cost incurred just by driving two piles into the ground is small. The extra pile(s) are the primary added expense.

FIGS. 4A-4D represent one particular embodiment, and variations are possible. For example, the rigid member can be a variety of shapes, sizes, and/or materials that are strong enough to transfer forces to the other members using classical static analysis. The rigid member can be one part or a series of parts assembled together to make a rigid assembly.

The piles can be a variety of shapes. They can be beams exhibiting cross-sectional shape in the form of W, H, I, or another shape.

The piles can be aligned perpendicular to the torque tube (e.g., the axis of rotation) at a certain distance from each other. Alternatively, the piles can be positioned at other angles relative to the tube. They can be any distance from each other, and don't necessarily need to be centered around the tube.

The particular embodiment of FIG. 4A shows two piles. However this is not required, and as the loads become larger three or even more piles could be used. The multiple piles can be set at a desired height off the ground. They can be used to support a variety of driving mechanisms.

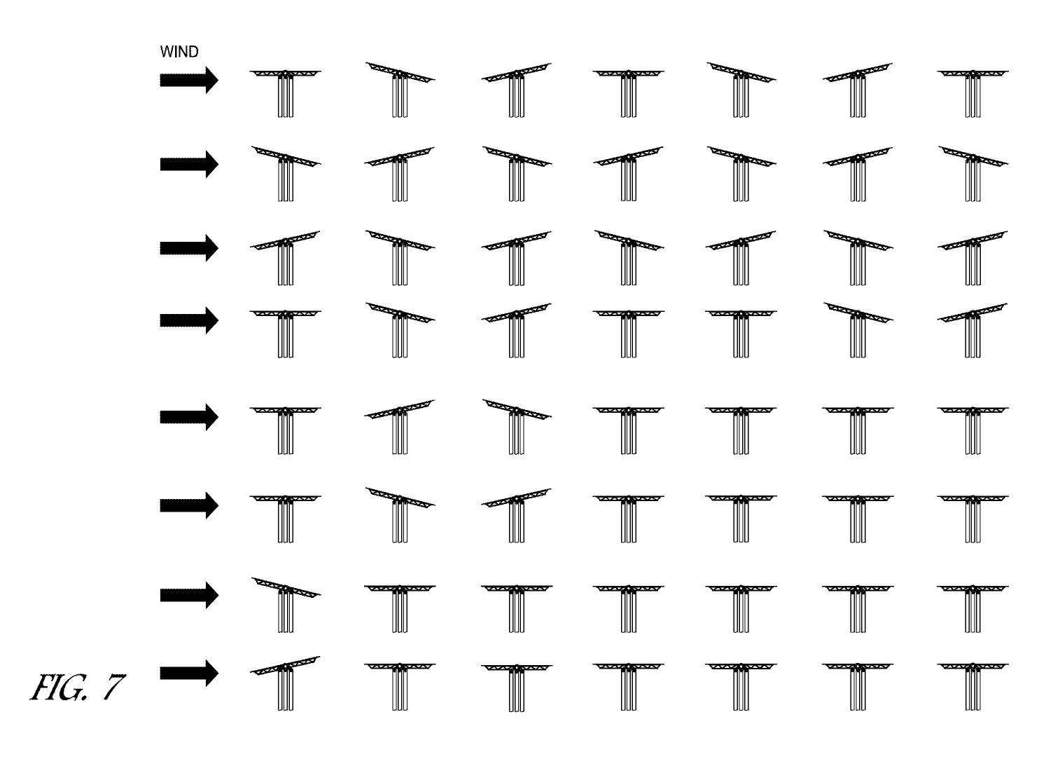

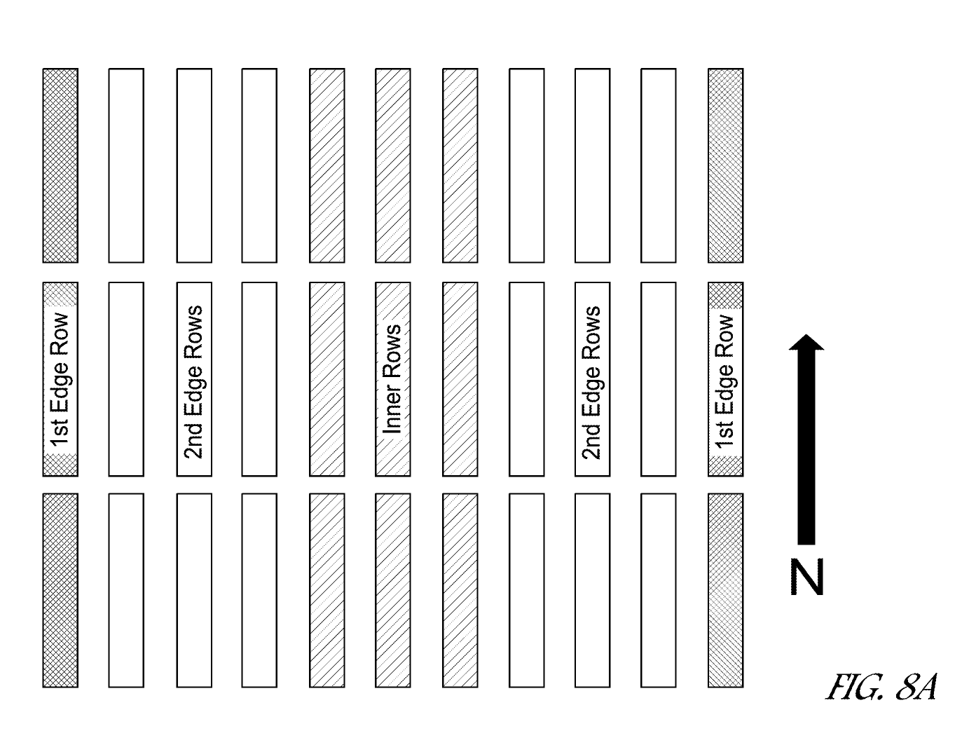

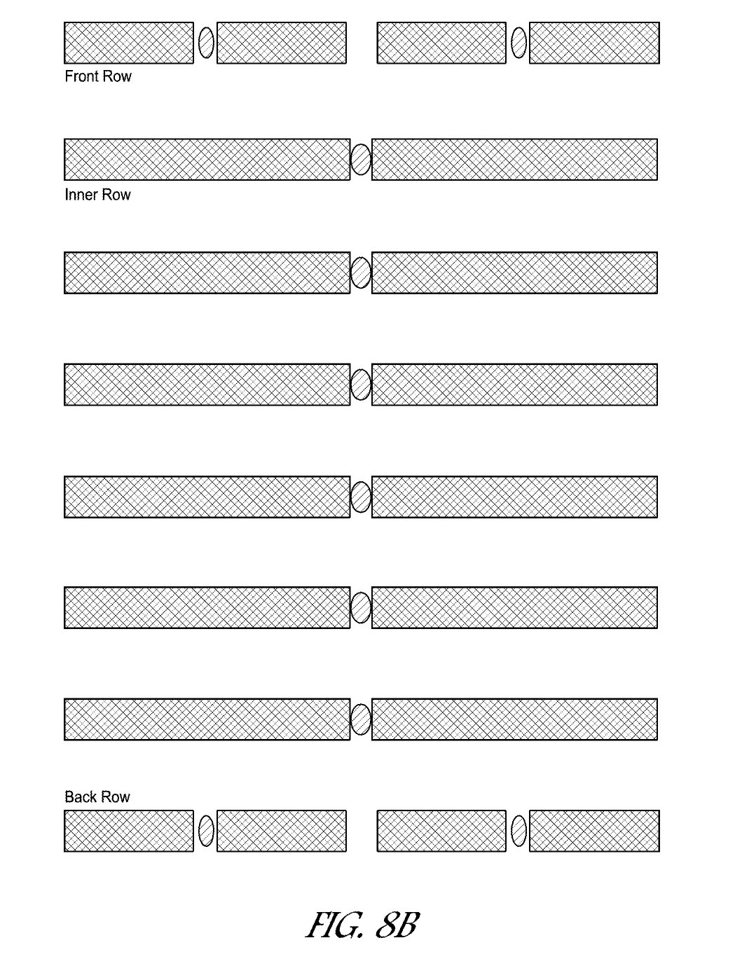

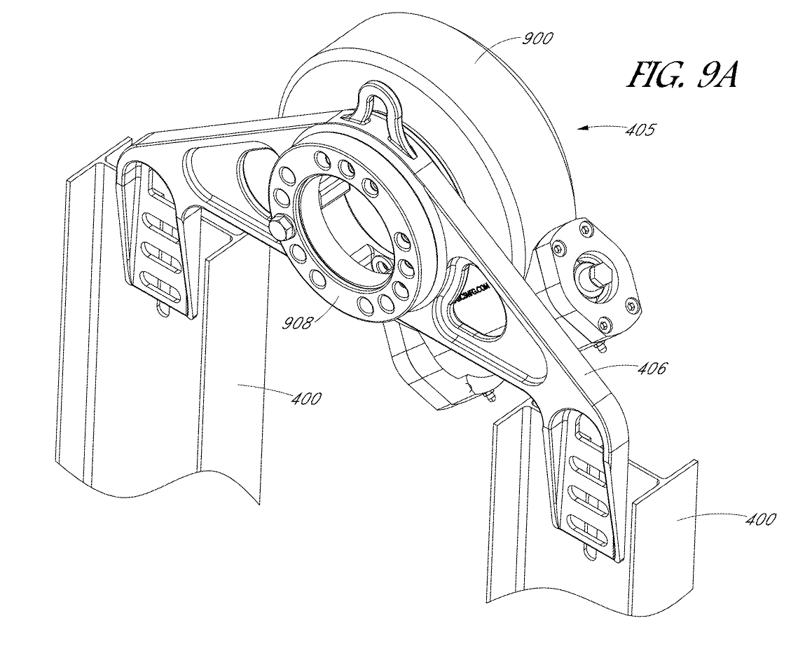

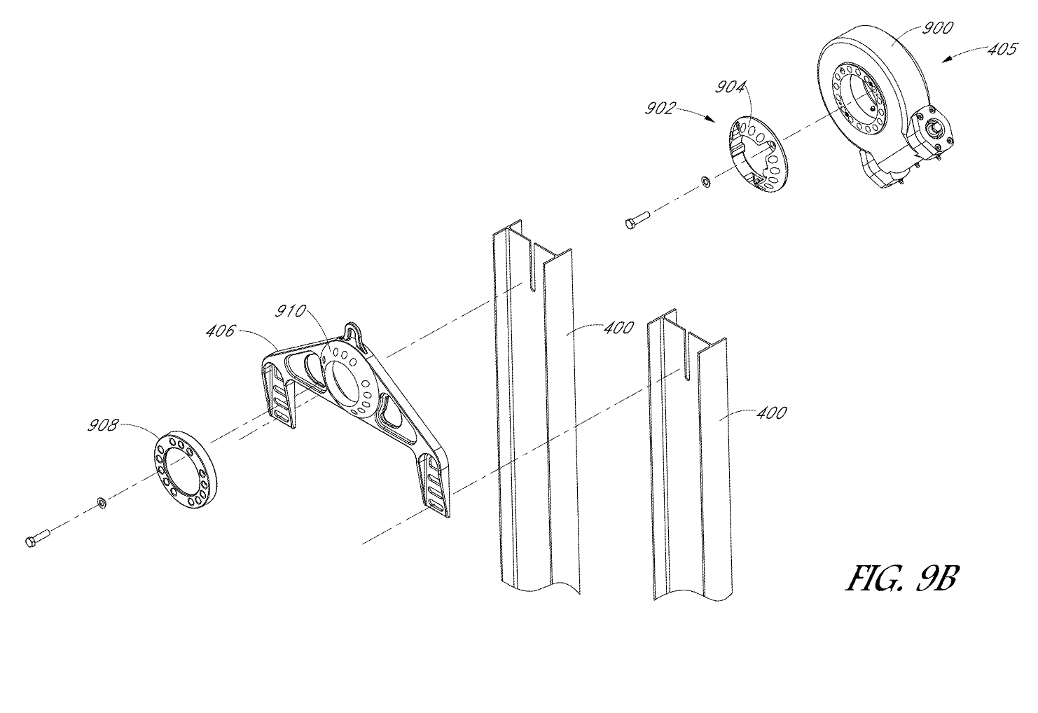

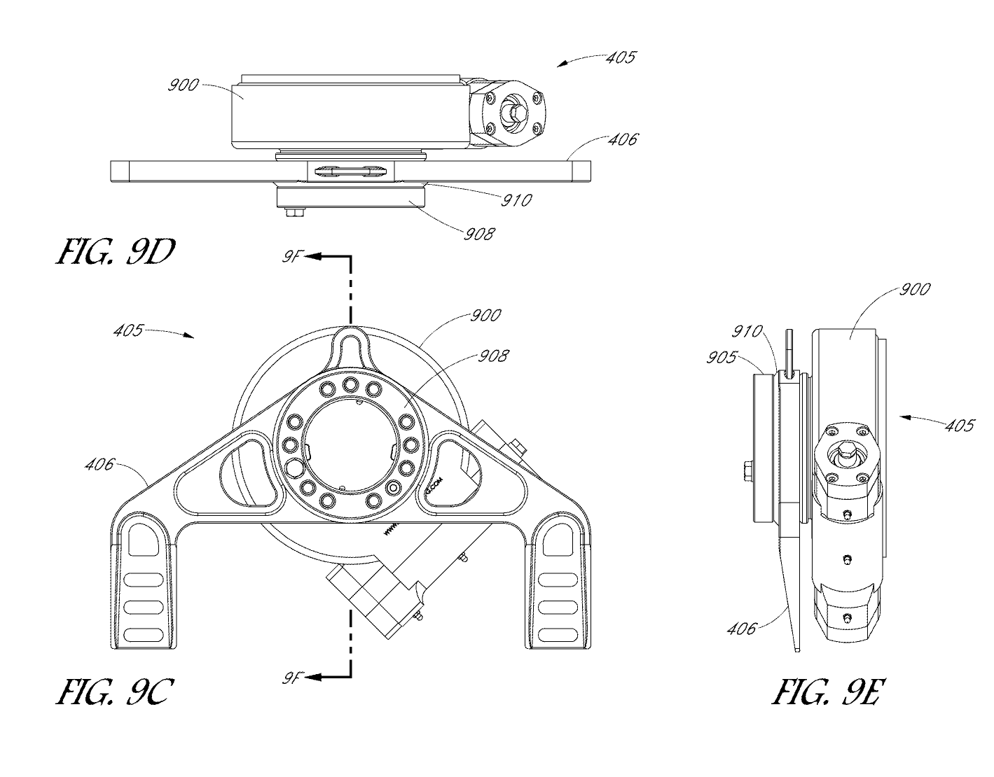

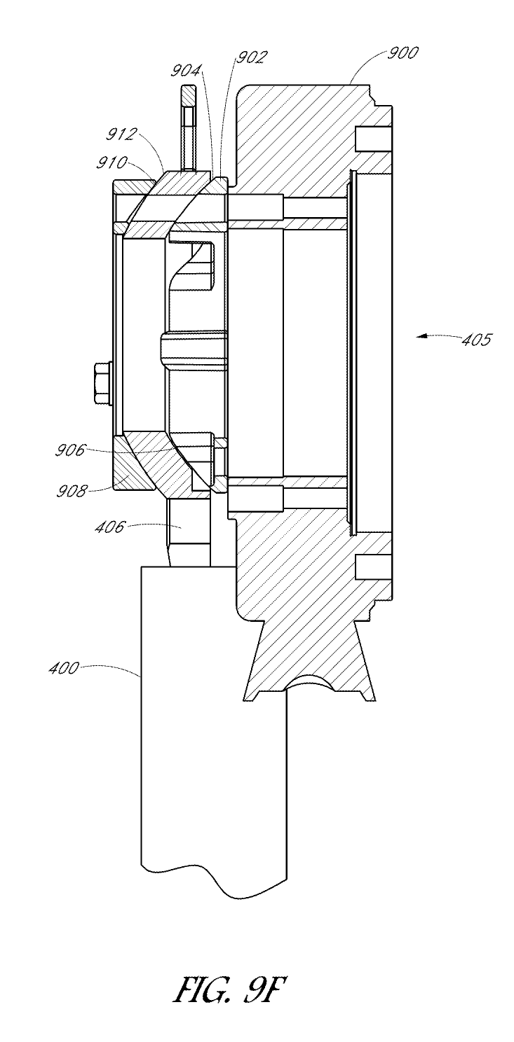

The drive mechanism just described represents one particular embodiment, and others are possible. FIGS. 9A-9F show various views of an alternative embodiment of a drive mechanism.

In particular, when installing the driving mechanism on the double pile design, there may be a risk of misalignment of the piles. This in turn can result in a misalignment between the torque tube and the next bearing along the length.

Accordingly, an alternative embodiment of a drive mechanism includes curved (e.g., spherical) surfaces that allow the slewing drive to be positioned to face the correct direction, while remaining firmly attached to the piles. The entire assembly can be installed on the piles in a nominal position.

FIG. 9A shows an isometric view and FIG. 9B shows an exploded view. FIGS. 9C-9E show various perspective views. FIG. 9F shows a sectional view taken along line 9F-9F′. In the illustrated example driving mechanism 405 comprises an adapter ring 902 attached to slew drive 900. Adapter ring 902 has a convex curved (e.g., spherical) surface 904 that is seated against a complementary curved concave annular surface 906 on rigid member 406 (see FIG. 9F). This arrangement allows the rotation axis of the slew drive to be adjusted with respect to the orientation of rigid member 406 and of piles 400 to correct for misalignment of the piles with respect to the intended rotation axis of the tracker. Slew drive 900 is secured to rigid member 406 with securing ring 908 positioned on the opposite side of rigid member 406 from slew drive 900 by bolts that pass through rigid member 406. Securing ring 908 has a concave curved (e.g., spherical) surface 910 that is seated against a complementary curved convex annular surface 912 on rigid member 406 (See FIG. 9F. This allows the orientation of securing ring 908 to be adjusted to correspond to that of slew drive 900 and thereby align the axes of the bolt holes so that the bolt heads tighten flat.

When the installers attach the torque tube, they may find that the parts are not aligned properly. The installers can then loosen the bolts, shift the slew in the required direction, and then re-tighten the bolts.

An embodiment as in FIGS. 9A-9F may offer one or more benefits. One is that no special alignment tools are required upon installation. Another is that the alignment process can be performed after the torque tubes are installed and the problem is identified. There is no need to disassemble the tracker.

Finally, if the piles are installed incorrectly, they do not need to be adjusted or replaced.

Variations on the particular embodiment shown in FIGS. 9A-9F, are possible. For example, curved surfaces 906 and 912 on rigid member 406 could be:
slew side concave, opposite side convex;
slew side convex, opposite side concave; or
both sides convex or concave.

In any of these variations the curved surfaces on adapter ring 902 and securing ring 908 may be shaped to be complementary to the curved surfaces on rigid member 406 against which they are seated.

Other variants allow embodiments to work with other slew drive actuator designs. The number of bolts can vary. Embodiments can apply to single and double pile designs, and the connection to the piles could be different. Rather than use an adapter ring 902, a curved surface could be built into the slew drive. Use of securing ring 908 is optional. For example, securing ring 908 may be replaced by washers having curved (e.g., spherical) surfaces, one washer for each bolt, that similarly allow the orientation of the bolt axes to be adjusted to align with the slew drive. In such variations the surface of rigid member 406 against which the washers seat may be flat rather than curved.

Solar Panel Attachment/Mounting

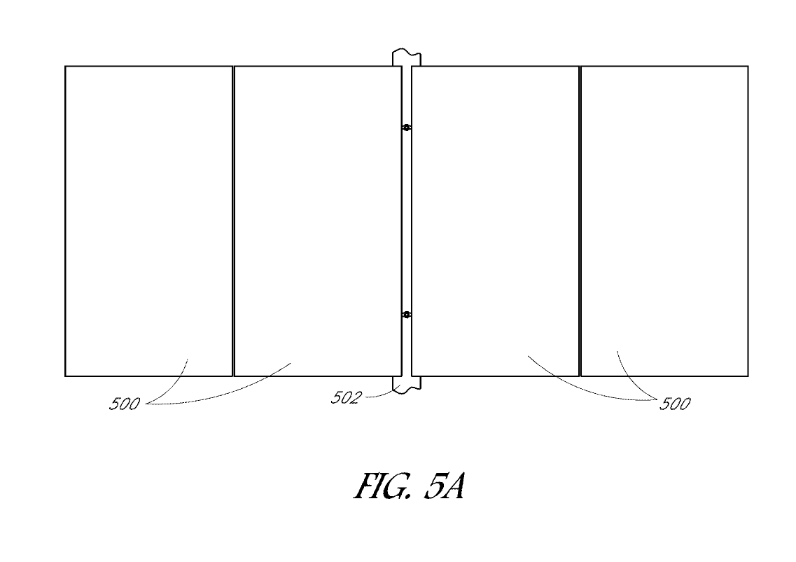

As shown and described above in FIGS. 1-3, solar panels may be mounted to the tube in a variety of ways. FIGS. 5A-5G are various simplified views illustrating a solar panel attachment and mounting approach according to an embodiment. This embodiment shows the panels oriented in a landscape configuration along the tube. Other embodiments could also contain solar panels in portrait or other configurations.

In particular, FIG. 5A is a simplified top view showing four solar modules 500 attached to the torque tube 502. FIG. 5B is a simplified underside view of the configuration of FIG. 5A.

In particular, the underside view of FIG. 5B (close up view in FIG. 5C) shows a plurality of solar panel attachment features 504 each connected to a module support arm 506. There may be one, two, or more such attachment features per module connected to each support arm.

The solar panel attachment features shown in FIG. 5B may be attached to the overlying modules by glue, for example. As shown in the perspective view of FIG. 5D, the attachment feature 504 rests on top of a module support arm 506. Details regarding the structure of that module support arm, including its truss design, are shown and described later.

FIG. 5E1 shows a view of the attachment feature from the perspective along the arm. FIG. 5E2 shows a view of the attachment feature from the perspective of the top surface supporting the panel.

The attachment feature is an assembly of parts. FIG. 5E3 shows a side view of the attachment feature, illustrating two parts within the design, a pawl block 510 and a slide 512. In particular, two slides of the attachment feature are clicked into place to lock the module on the support arm.

FIGS. 5F1-5F3 show views of this attachment process. Specifically, slides 512 are installed inside the pawl block 510. As shown in FIG. 5F1, the installer places the module having the pawl blocks glued to its underlying surface, on the arms. At this point the module can slide freely.

As shown in FIG. 5F2, the installer pushes the slides into the center. The front end of each slide will insert into a node of the module support arm truss structure. The sliders, and hence the pawl block and the overlying module to which it is attached (e.g., by glue) are thereby locked into place. As illustrated, each slider may be locked in place by, for example, a ratchet mechanism comprising teeth 514 on an (e.g., upper) surface of the slider engaged by a corresponding pawl 516 on the pawl block.

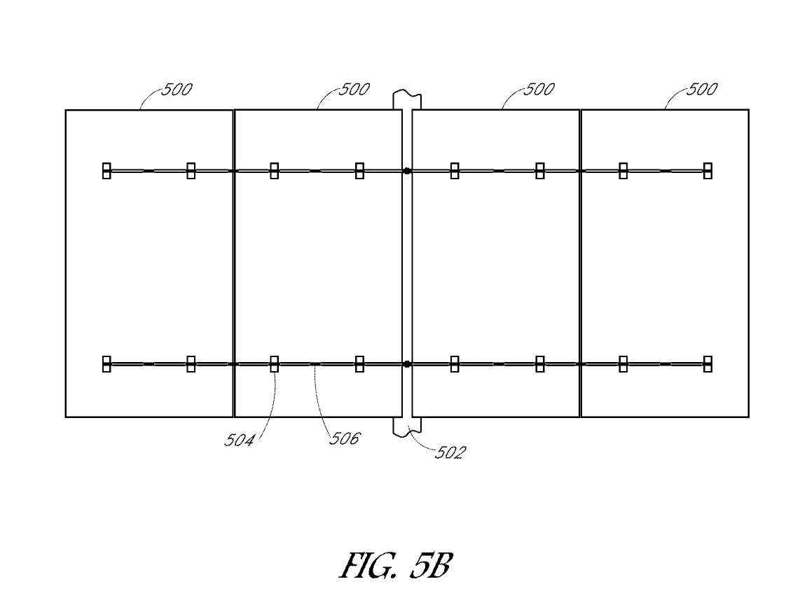

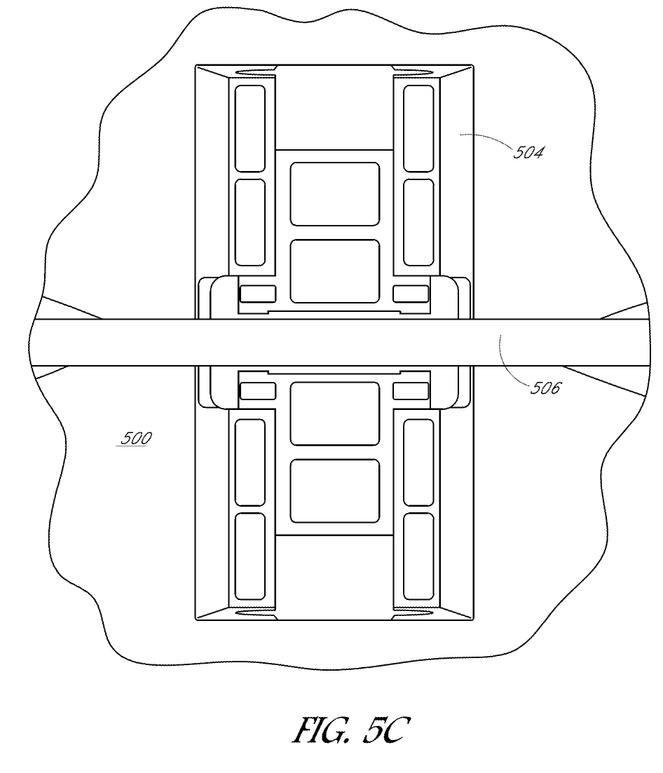

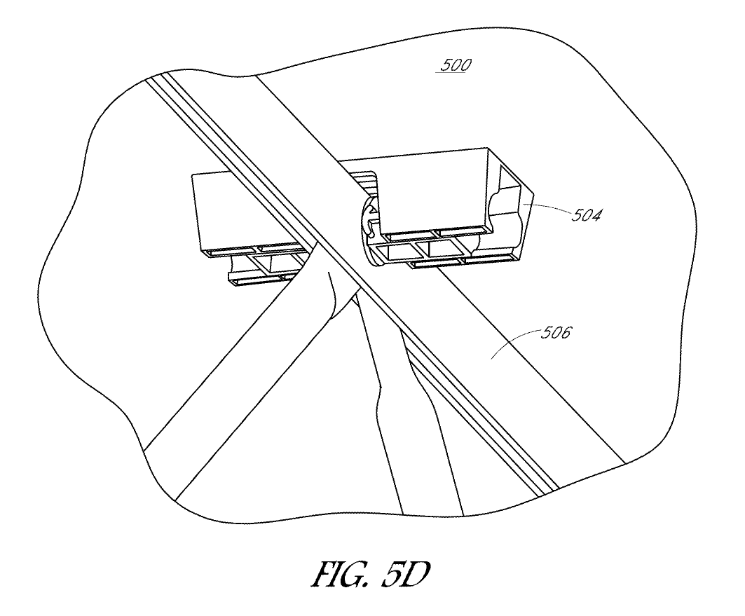

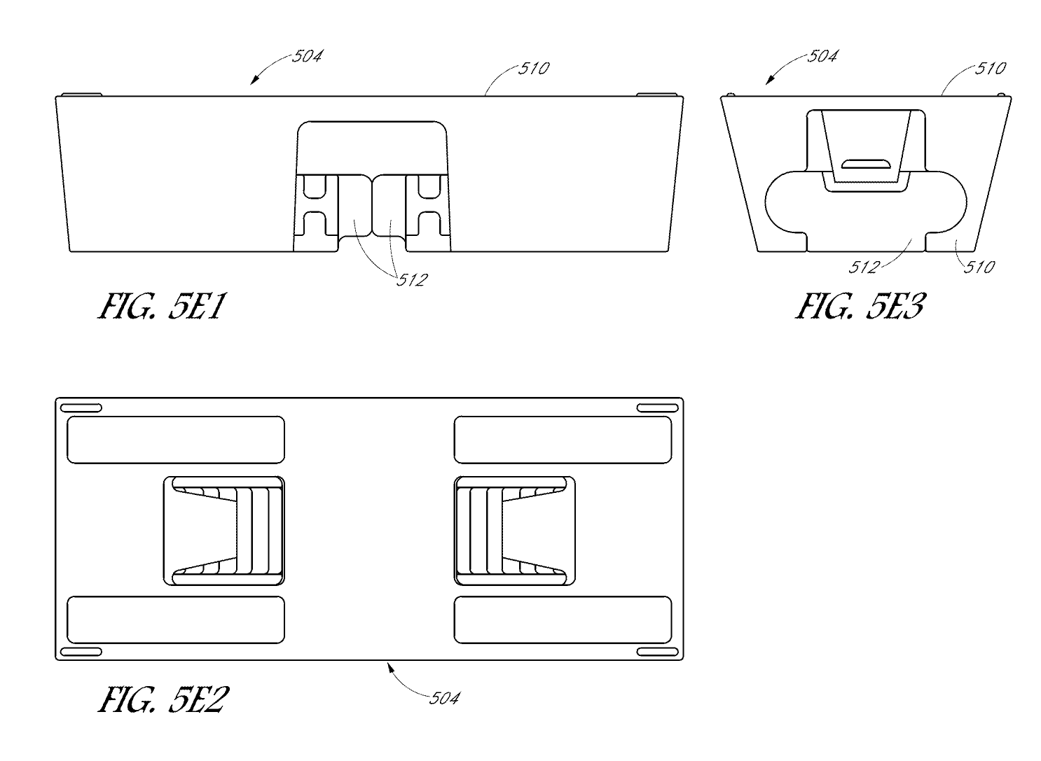

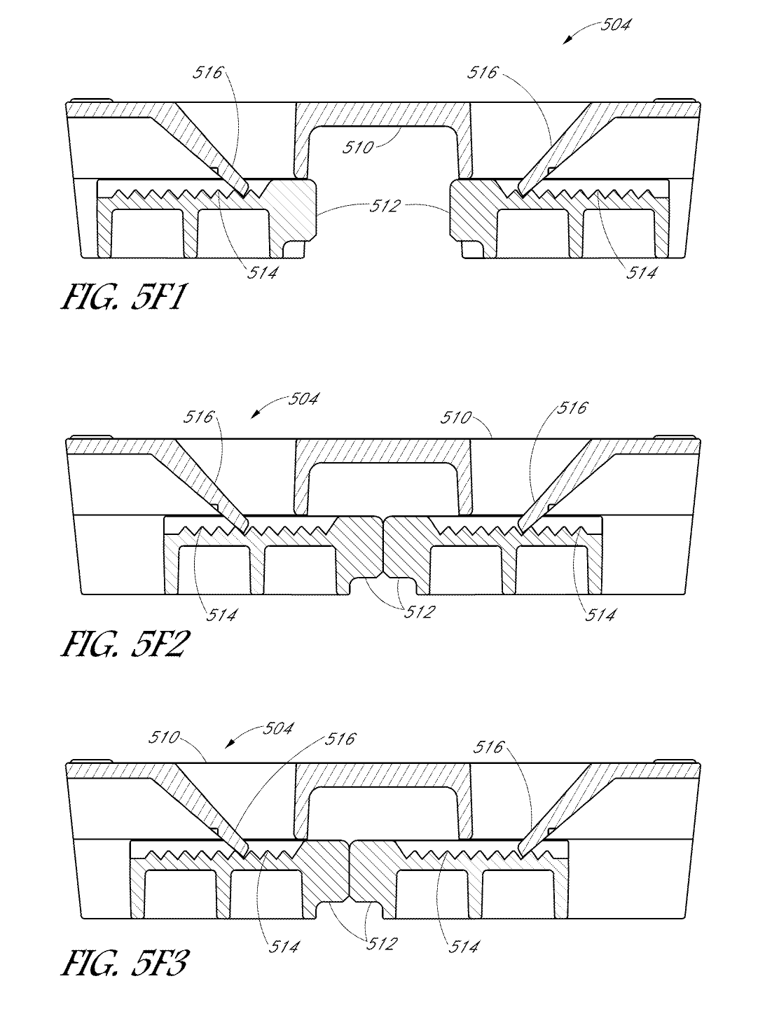

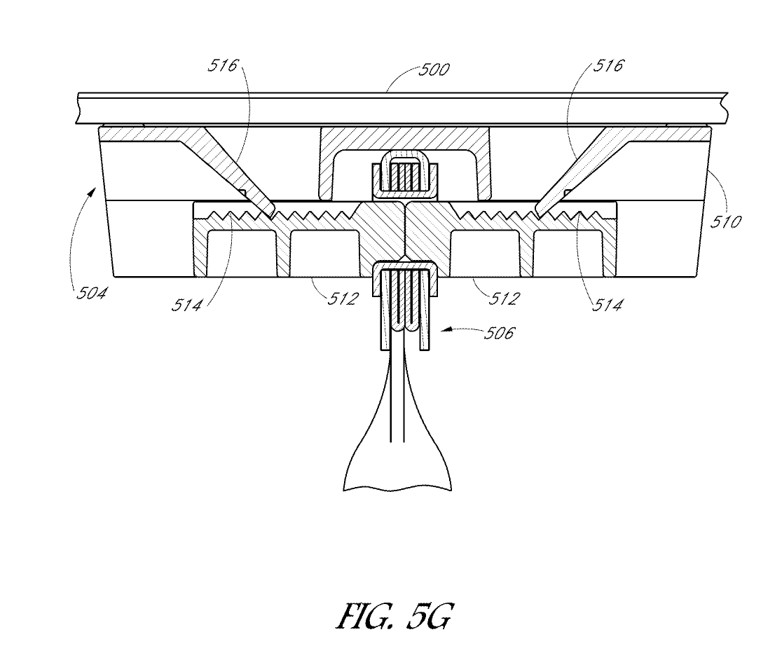

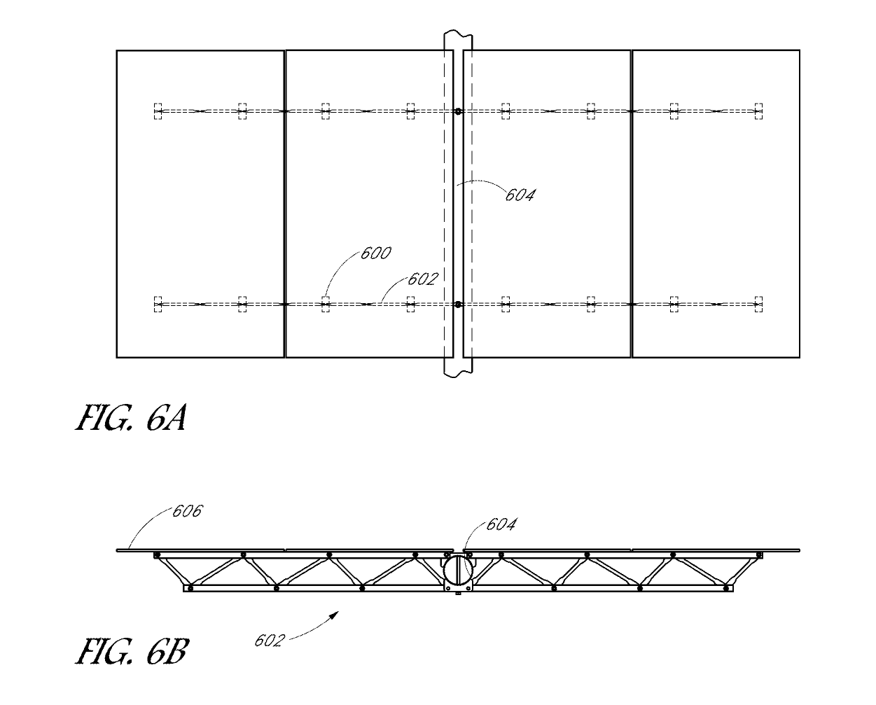

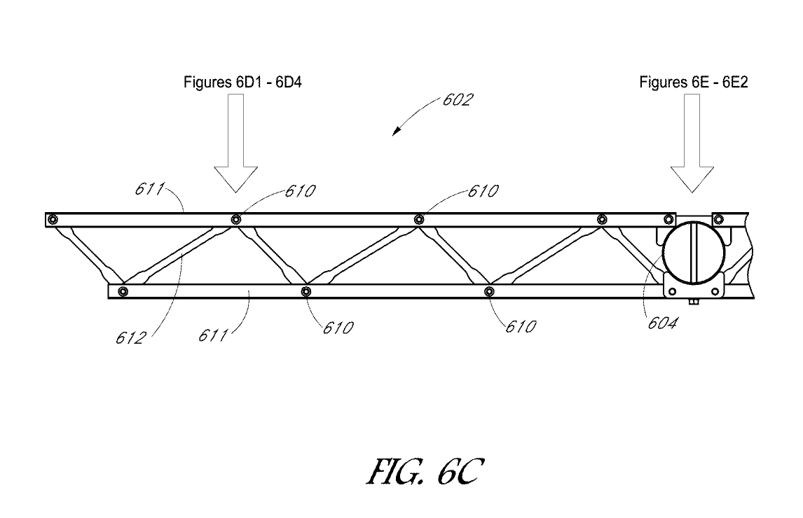

This aspect is shown in connection with FIG. 5G. Further details regarding the node on the module support arm structure are provided later below in connection with FIGS. 6D1-6D4.

The alternative view of FIG. 5F3 shows the slides and pawl block designed so that the module support arm can be locked in place at any position within the pawl block gap. This could be useful if a module support arm is not quite in the correct location along the torque tube.

Operation of the attachment features is now discussed. Specifically, when the wind blows the solar panel can be pushed down or lifted up. The resulting force will be transferred through the pawl block and slides, and into the nodes of the arm truss.

These attachment features according to embodiments may offer one or more advantages. When a tracker has a larger solar panel area, the overall height of the tracker will need to grow. This makes it very hard to install the solar panel from above without special equipment and tools. The modules in this design are attached to the module support arms from below. This design reduces labor and allows for the structure to be taller without using special equipment. Additionally, the design does not require extra parts or hand tools for installation. This drastically reduces the time to install a solar panel on the module support arms.

The attachment features are adhered to the back of the panel and inset from the four edges. Their location is selected to reduce the stress on the solar panel to the minimum possible. A lower stress could justify a reduction in the thickness requirement for the glass and the stresses that will be transferred to the internal components of the solar panel.

When the supporting features of the solar panel are attached to the back side of the panel, there is not a need for a frame around the outside of the solar panel. This reduces the cost of the solar panel and makes it easier to manufacture.

Because there are no metal components in electrical contact with the internal components of the solar panel, there are no grounding wires required. This reduces cost, complexity, installation labor and risk of shock or electrocution.

Embodiments may allow for fast installation with no tools (e.g., the sliders may be slid into the pawl block using finger strength) or extra parts. This reduces installation time and costs.

The slider engages directly with the node of the truss structure. When a wind gust imparts a force on the modules, the forces are transferred directly to the nodes. This embodiment permits the design of the module support structure to be highly efficient. This becomes very important for larger solar panel areas. As the width of the tracker is designed to be larger, the support structures need to support higher forces along the increased length. By transferring the forces through the node, less material can be used in the truss members, thus reducing the cost.

The material cost is low because a low cost material and manufacturing method can be used.

As illustrated in FIG. 5F2 and 5F3, relatively large tolerances on the module support installation are permitted. When installed, the slides 512 can be positioned and fixed at multiple locations, depending on how accurately other parts were installed. This flexibility reduces installation time and costs.

The particular structures shown and described above in connection with FIGS. 5A-5G represent only one specific embodiment, and variations are possible. For example, the parts can be made of materials desirable for a particular environment.

The method of attachment to the module support arms does not need to be through the node. The number of slides is not limited to two, and more or fewer could be employed.

Also, the pawl block does not need to be glued to the module. It could be affixed to the module in other ways, for example utilizing mechanical fasteners.

Module Support/Attachment Feature

As shown and described above, a single-axis tracking approach according to embodiments may have a solar module rest upon a module support structure (e.g., comprising module support arms as described above) and secured thereto via the attachment features, that is in turn rotated by the tube. For larger solar panel areas with a wide width, the module support structure needs to withstand a large amount of force. As is now described, particular embodiments may utilize module support arm structures in the form of a truss.

A truss is an efficient structure because it turns bending moments into basic tension and compression forces in the truss members. Less material can thus be used, and the cost can be lowered.

A challenge is how to attach each truss member together, and how to attach the truss members to the torque tube in a cost effective way. Embodiments may utilize a grommet-like structure that is an improvement compared to a typical fastener design or to welding. This embodiment captures the members in place with the grommet to create the node of a truss structure while providing a mounting feature that other components can be attached to.

The truss is designed to terminate at brackets attached to the torque tube. The truss members are only actually tension and compression members if the loads are applied through the nodes of the truss. The special design of the nodes creates a location to attach the modules as well as the attachment of the truss members. This means the members can be designed to be as efficient as possible.

The structure of this module support structure according to one embodiment is now discussed in connection with FIGS. 6A-6F2. In particular, FIG. 6A shows a top view of a module, with the panels rendered transparent for clarity of illustration. Shown underlying the panels are the attachment features 600, the module support arms 602 to which they are affixed, and the torque tube 604.

FIG. 6B is a simplified side view of the module of FIG. 6A, this time with the panels 606 shown. FIG. 6C shows an enlarged side view of a module support arm structure.

FIGS. 6D1-6D4 show various aspects of a module support arm. In particular, FIG. 6D1 shows an enlarged perspective view illustrating a node 610 of a truss structure formed by truss members 612 (shaped beams with flattened ends 613) and truss members 611. FIG. 6D2 shows a cross section of a truss member 611 in the form of bent sheet metal. The node of the truss is designed to be a low cost, secure attachment between the truss members, and a simple connection point of the module attachment feature.

FIG. 6D3 shows the grommet feature 614 of the node. It is formed around truss members and serves to pin parts together, as shown in the simplified assembled view of FIG. 6D4 showing a cross-section of the node. It is noted that the previous FIG. 5G also shows a cross-section of the node with the attachment features slid into position.

It is noted that the torque tube is round, so connecting a support arm there can be challenging. This connection needs to withstand a large torque when wind pushes or pulls on the modules. Square tubes can be easily attached to because the shape naturally resists the torque. Round tubes do not resist torque on their own so special features need to be designed to withstand the torque. This becomes especially challenging with larger solar panel areas on the tracker because the torque at the connection becomes even larger.

Accordingly, FIGS. 6E-6E1 show views of embodiments addressing this issue. Holes are drilled in the top and bottom of the torque tube. Once the tube is installed on the piles, a mount comprising two pieces 620, 622 is fixed onto the tube with a bolt 624 through the hole. This connection is easy to install, low cost and strong enough to withstand large torques.

The installer then attaches the preassembled truss structure. The mount defines a top slot 626 and a bottom hole 628 useful for this purpose.

In particular, the support assembly was designed to be easily installed with very few tools or extra components. A process was developed to hook the part on using a slot 626 in a top of the mount, and then pivot the assembly down into a bracket where only one bolt needs to be installed to secure the structure to the torque tube. This is shown in FIGS. 6F1-6F2, wherein the truss pivots around a slot in the top of the mount, and then a bolt is installed on the bottom to lock the truss/arm in place on the tube.

Embodiments of arm structures may offer advantages of low cost and strong connection between truss members. Connection between truss members doubles as a module connection point, thus making the truss members more efficient.

The connection to the round torque tube is resistant to torsion with minimal material consumption. The connection allows for a round torque tube, which is a more efficient torque carrying shape, to be used. No welding is required on the tube structure.

The assembly of the structure in the field can be rapid. Trusses hook on and attach with one bolt.

This installation method makes installation lower cost on a tracker with a large solar panel. The installer does not need any special equipment to lift and install the assembly. From the ground, the structure can be assembled by one person with minimal tools.

Variations on the precise structure illustrated, are possible. For example, the truss can have any number of nodes spaced at any distance from each other.

The mount to the tube could have a bolt installed at the top and then the part could be swung down into the bracket at the bottom and installed with a second bolt.

The module attachments do not need to transfer the forces through the nodes. For example, the node can have a hole in it (as shown), or be solid. Thus the grommet feature is not required to be included in every embodiment.

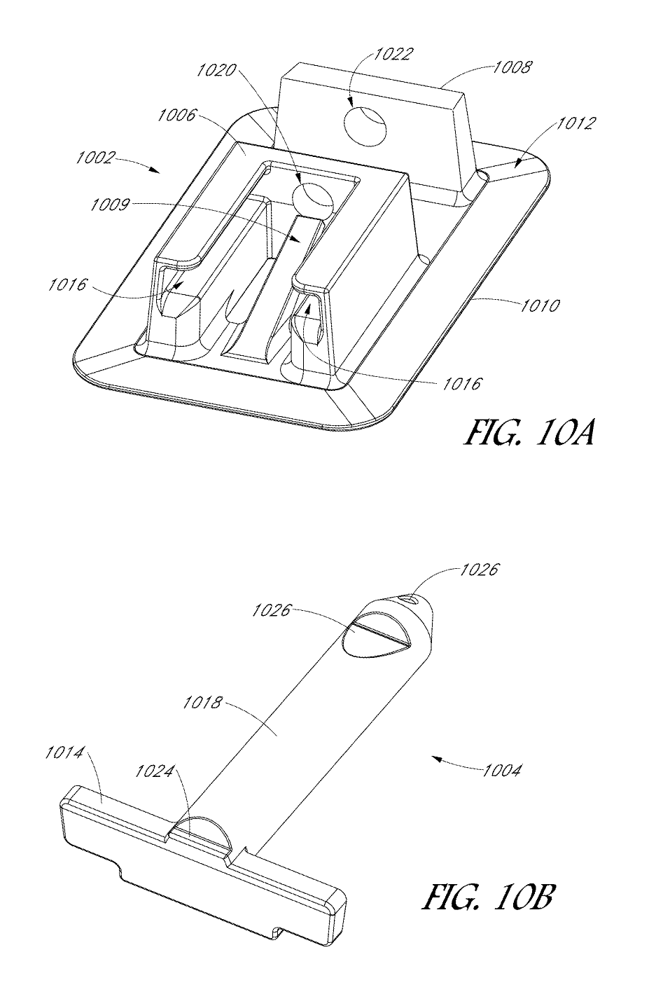

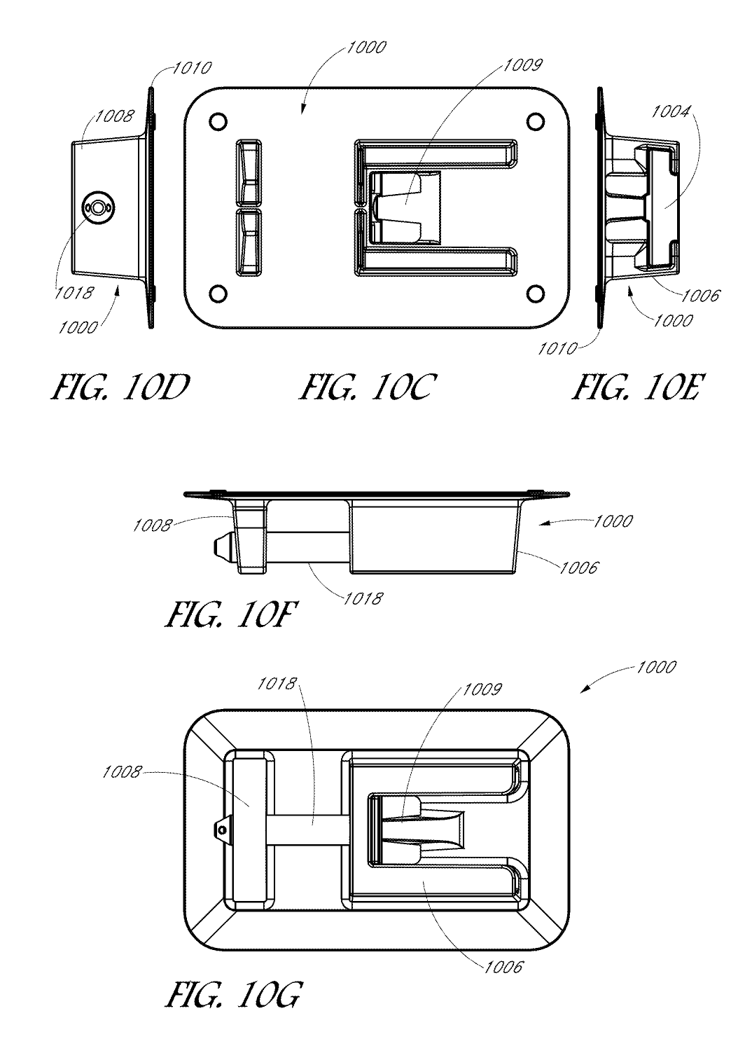

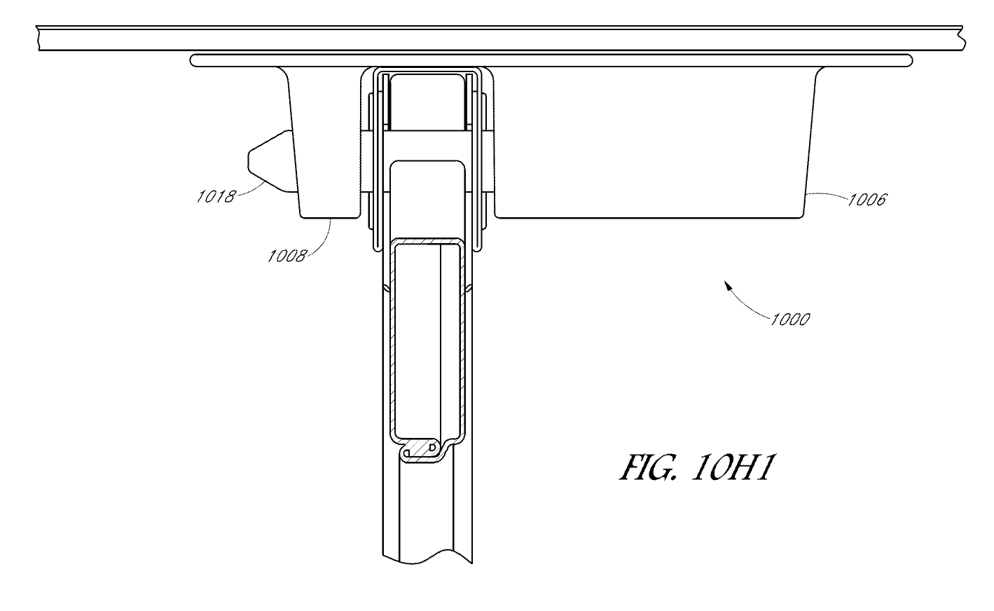

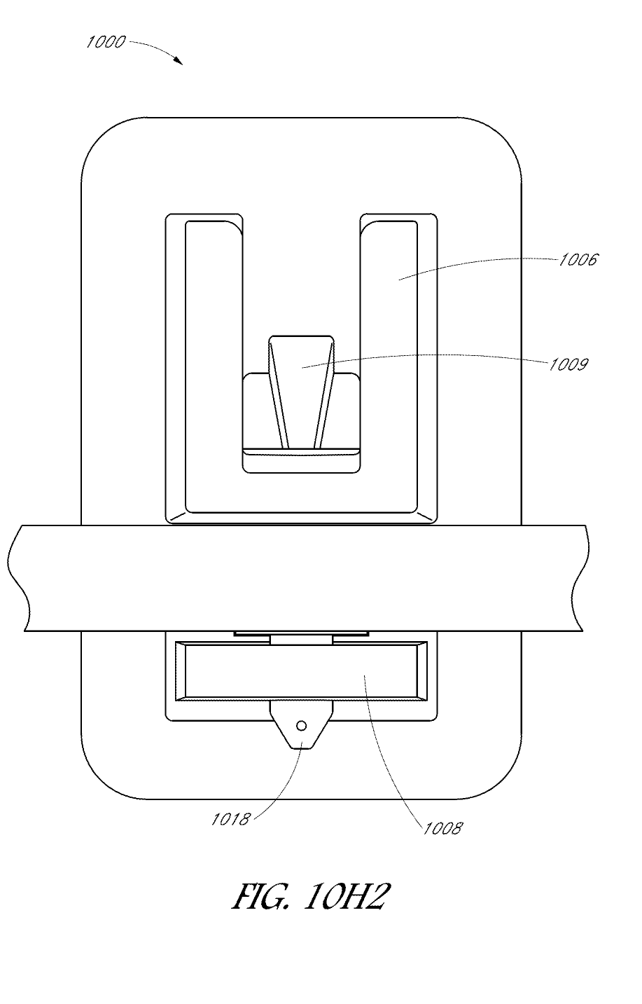

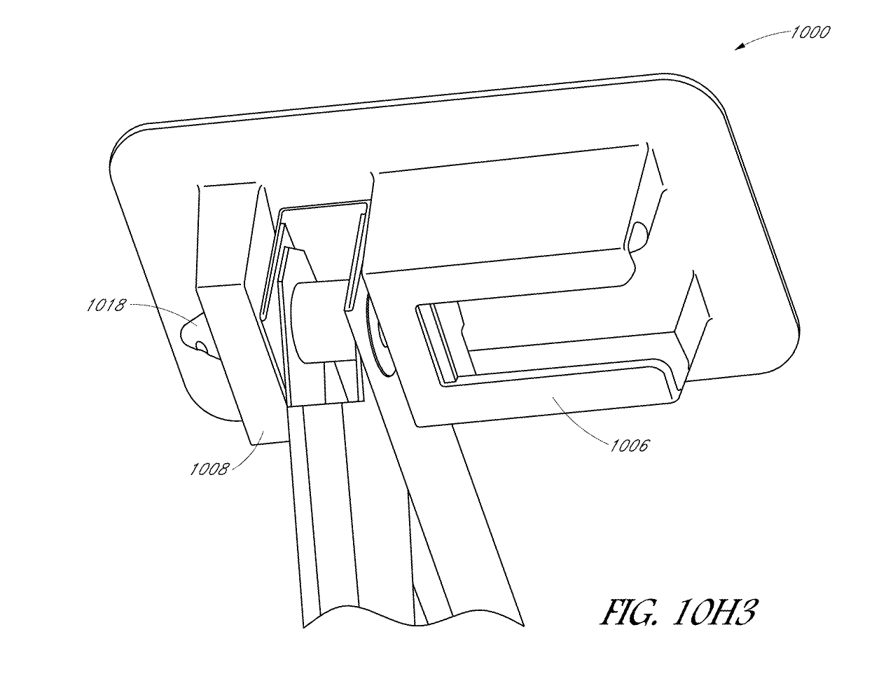

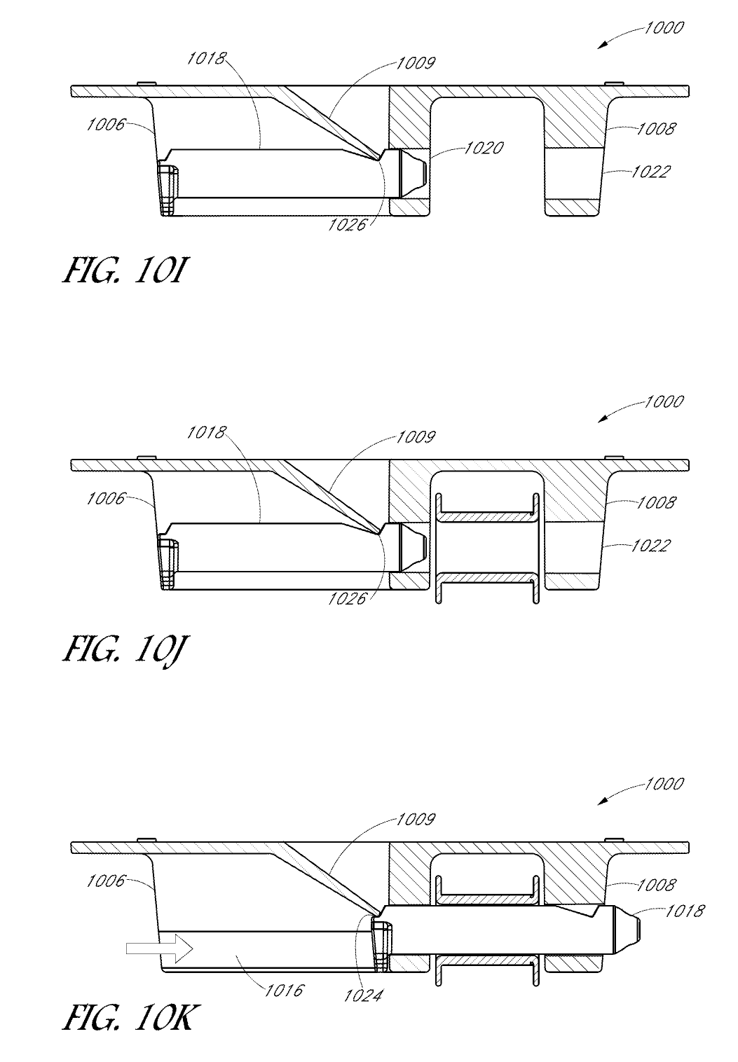

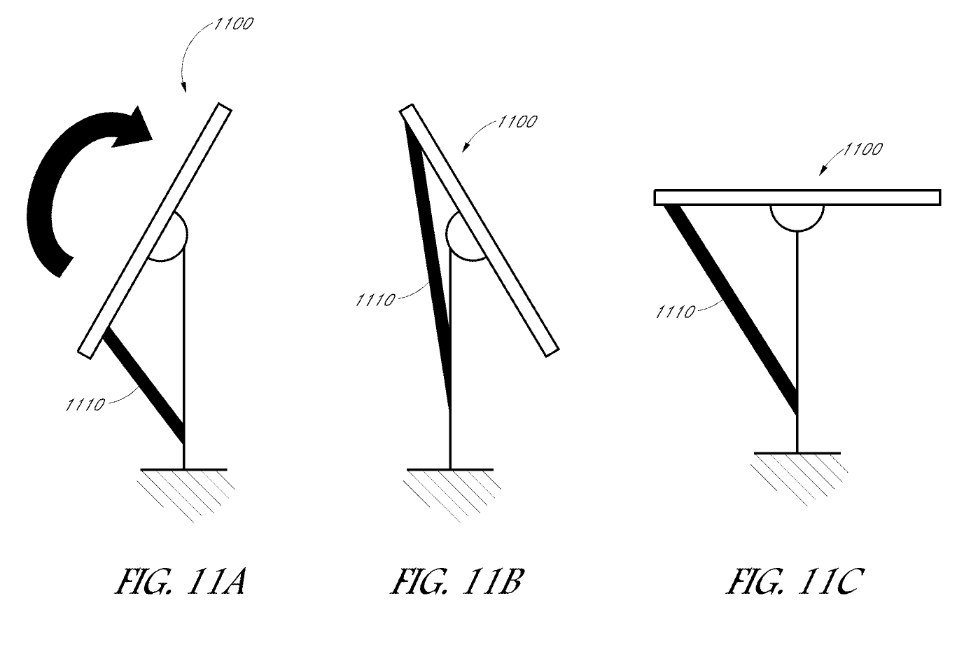

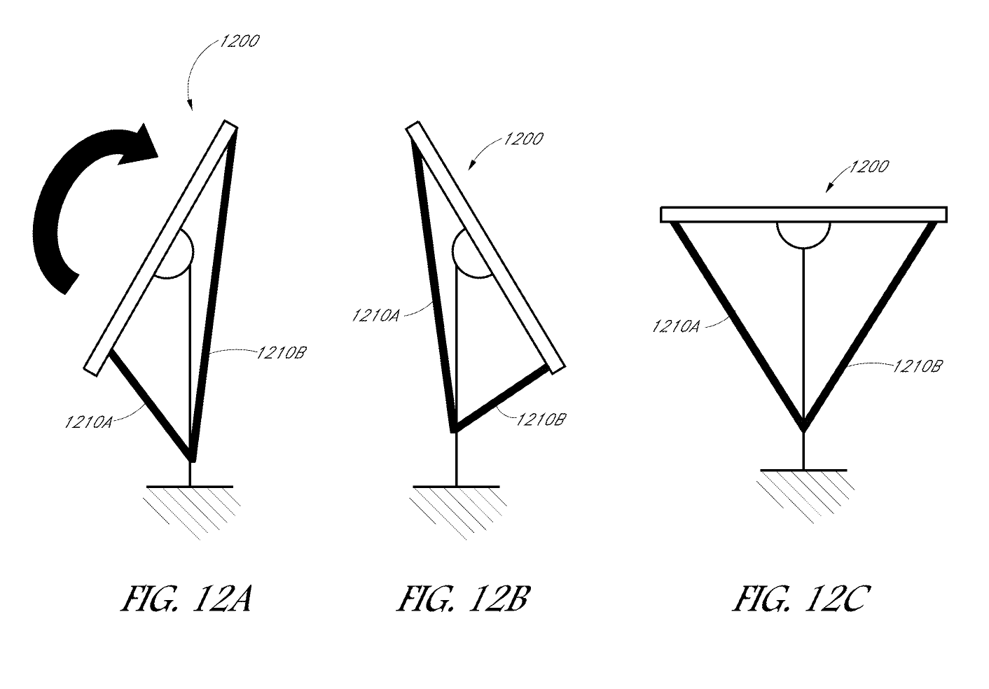

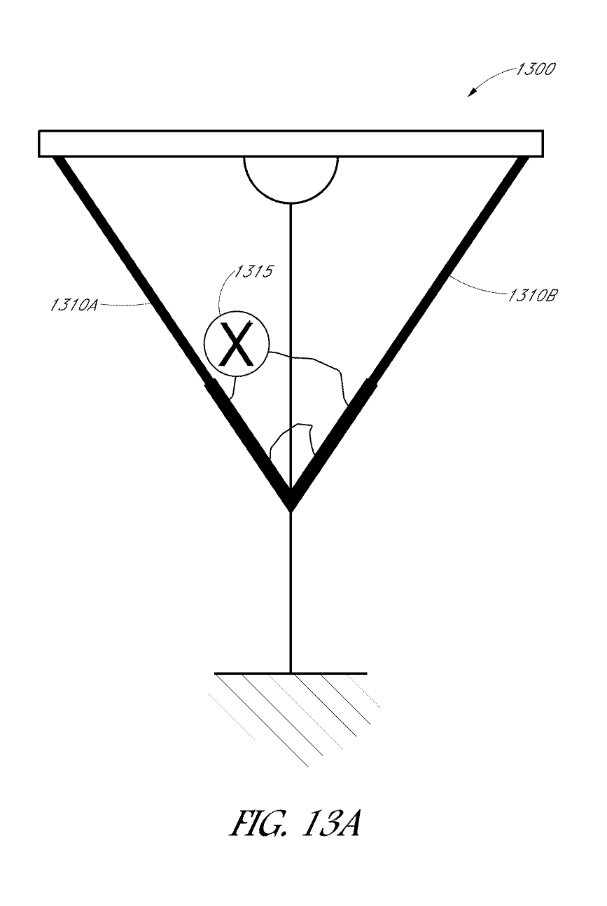

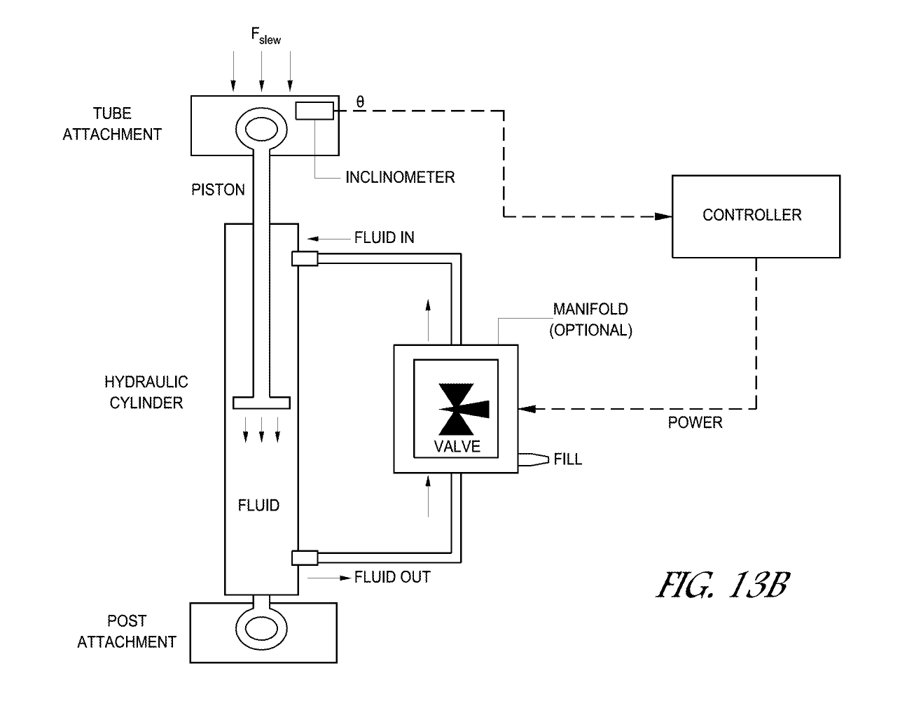

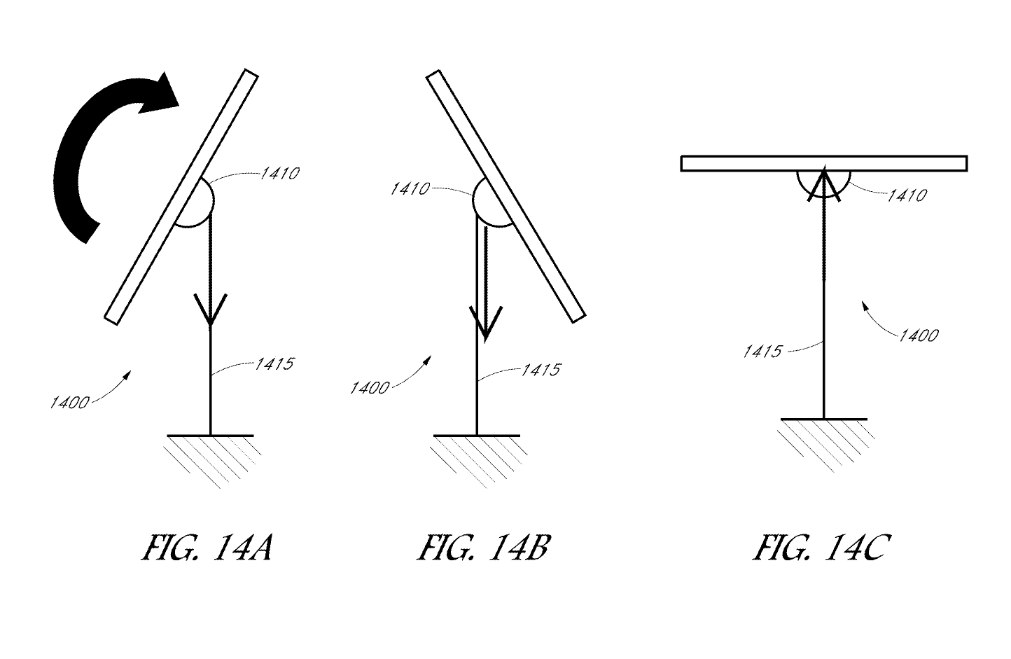

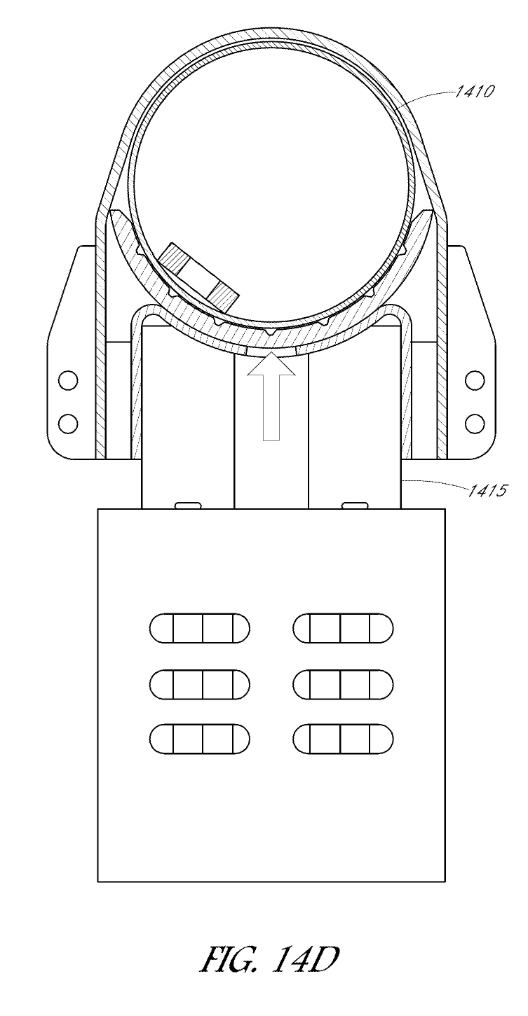

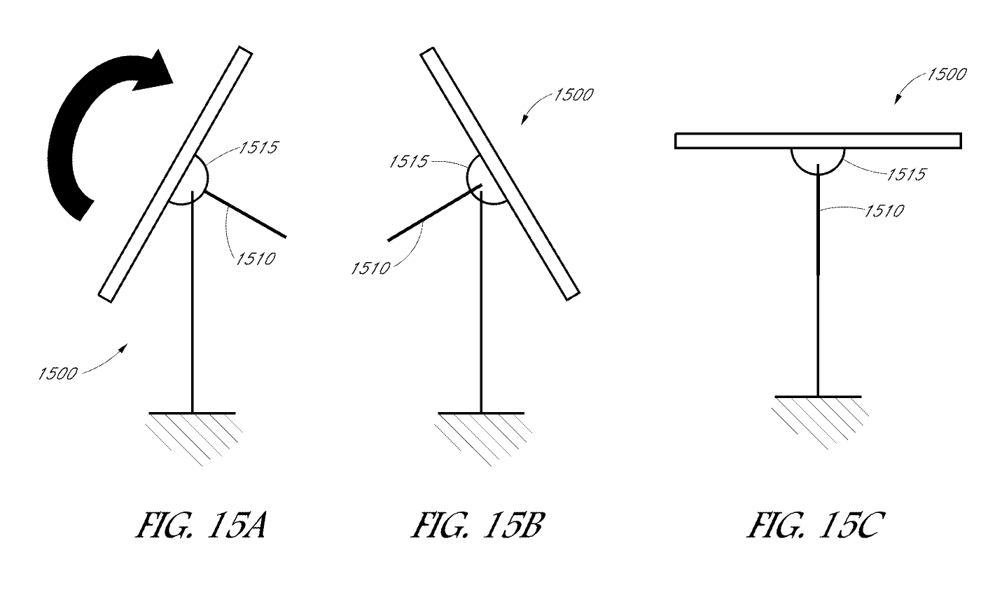

FIGS. 10A-10I show various views of an embodiment of a panel mounting scheme that uses an alternative embodiment attachment feature 1000. Attachment feature 1000 comprises a pawl block 1002 and a slide 1004. FIG. 10A shows a perspective view of pawl block 1002. In the illustrated example, pawl block 1002 includes slide supports 1006 and 1008 and pawl 1009 extending upward from a base 1010. Slide supports 1006 and 1008 are spaced apart from each other to provide a gap accommodating a portion of a support arm truss. The underside of base 1010 may be attached to an overlying module by glue, for example. Base 1010 extends horizontally outward beyond the slide supports to provide a stress transition area 1012 that protects the solar cells in the module from cracking as a result of being flexed over a hard edge.

FIG. 10B shows a perspective view of slide 1004. In the illustrated example, slide 1004 includes a transverse member 1014 configured to engage and slide in channels 1016 in slide support 1006, and a pin 1018 oriented perpendicularly to transverse member 1014 and configured to pass through hole 1020 in slide support 1006, through a node in a support arm truss, and then through hole 1022 in slide support 1008 to secure the support arm truss to the attachment feature (and thus to the overlying solar module). Pin 1018 includes a first notch 1024 that may be engaged by pawl 1009 to secure slide 1004 in a closed position, and a second notch 1026 that may be engaged by pawl 1009 to secure slide 1004 in an open position. Pin 1018 also comprises an optional hole 1026 through which a split pin or similar fastener may be passed to further secure slide 1004 in its closed position.

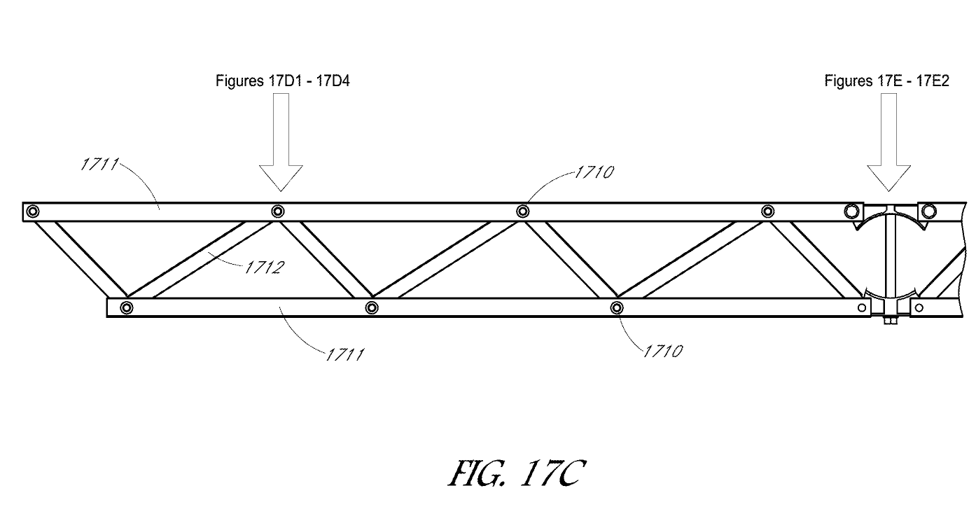

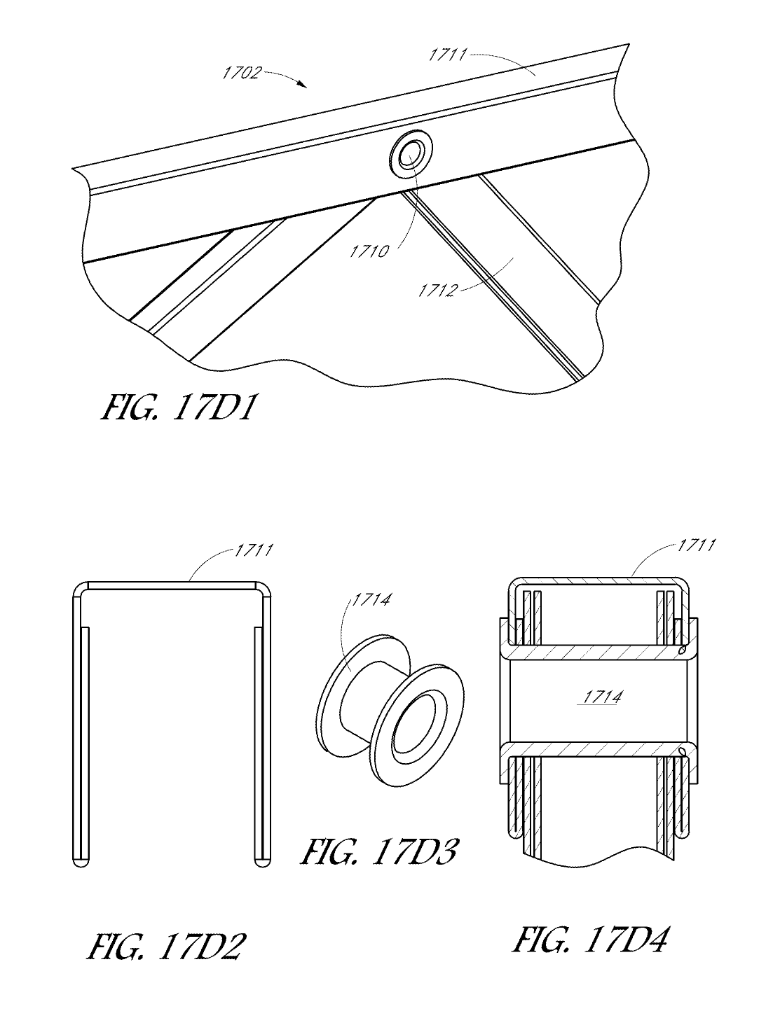

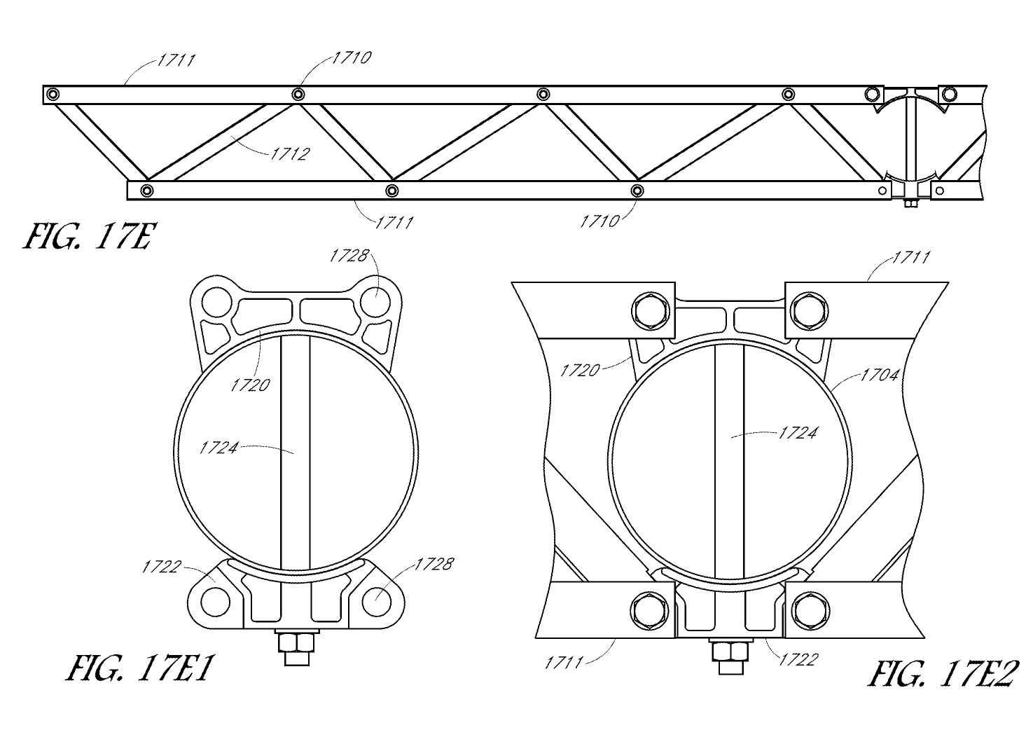

FIGS. 10C-10G are various perspective views of attachment feature 1004. FIGS. 10H1-10H3 show a grommet, forming a node in a support arm truss, fully captured by pin 1018. These views can further be understood with reference to FIGS. 17A-17E2 described below.

FIGS. 10I-10K show the grommet and insertion of pin 1018. FIG. 10I shows slide 1004 in the open position. Typically, the slide travels within the block in this open position during shipping. The slide is held in place in the open position by pawl 1009 engaging notch 1026. FIG. 10J shows pawl block 1002 placed over the support arm and the pin at least roughly aligned with the grommet (node). FIG. 10K shows the result of a user pushing the slide through the node. The ramped (angled) nose of the pin adjusts for misalignment. The slide is held in place in this closed position by pawl 1009 engaging notch 1024.

FIG. 17A-17E2 shows various views of a support assembly according to an alternative embodiment. In particular, FIG. 17A shows a top view of a module, with the panels rendered transparent for clarity of illustration. Shown underlying the panels are the attachment features 1700, the module support arms 1702 to which they are affixed, and the torque tube 1704.

FIG. 17B is a simplified side view of the module of FIG. 17A, this time with the panels 1706 shown. FIG. 17C shows an enlarged side view of a module support arm structure.

FIGS. 17D1-17D4 show various aspects of a module support arm. In particular, FIG. 17D1 shows an enlarged perspective view illustrating a node 1710 of a truss structure formed by truss members 1711 and 1712. FIG. 17D2 shows a cross section of a truss member 1711 in the form of bent sheet metal. The node of the truss is designed to be a low cost, secure attachment between the truss members, and a simple connection point of the module attachment feature.

FIG. 17D3 shows the grommet feature 1714 of the node. It is formed around truss members and serves to pins parts together, as shown in the simplified assembled view of FIG. 17D4 showing a cross-section of the node. The previous FIGS. 10H1-10H3 also show a cross-section of the node with the attachment features slid into position.

It is noted that the torque tube is round, so connecting a support arm there can be challenging. This connection needs to withstand a large torque when wind pushes or pulls on the modules. Square tubes can be easily attached to because the shape naturally resists the torque. Round tubes do not resist torque on their own so special features need to be designed to withstand the torque. This becomes especially challenging with larger solar panel areas on the tracker because the torque at the connection becomes even larger.

Accordingly, FIGS. 17E-17E1 show views of embodiments addressing this issue. Holes are drilled in the top and bottom of the torque tube. Once the tube is installed on the piles, a mount comprising two pieces 1720, 1722 is fixed onto the tube with a bolt 1724 through the hole. This connection is easy to install, low cost and strong enough to withstand large torques.

The installer then attaches the preassembled truss structure. The mount defines top and bottom holes 1728 useful for this purpose.

Tracker Stowing Techniques

For solar installations, wind can damage a solar tracker. A conventional approach is to stow an entire field of trackers in a flat or close to flat location.

When the driving mechanisms are connected together, all trackers turn to the same angle. Each tracker, however, does not experience the same flow of air.

Specifically, while a tracker on the edge of a group (e.g., at the edge of a field) may experience a fairly laminar flow, the others in different positions (e.g., in the 2nd, 3rd, or later rows etc.) may see various levels of turbulence. This turbulence can be the source of problems, for example resulting in dynamic loads causing oscillations and vibrations detrimental to the torque tube and/or the driving mechanism.

A benefit of each tracker having a separate drive is the ability to turn each system to its own desired angle in order to reduce the wind load applied to the inner trackers. In doing so, one or more configurations can be used to reduce the dynamic wind load on the inner systems.

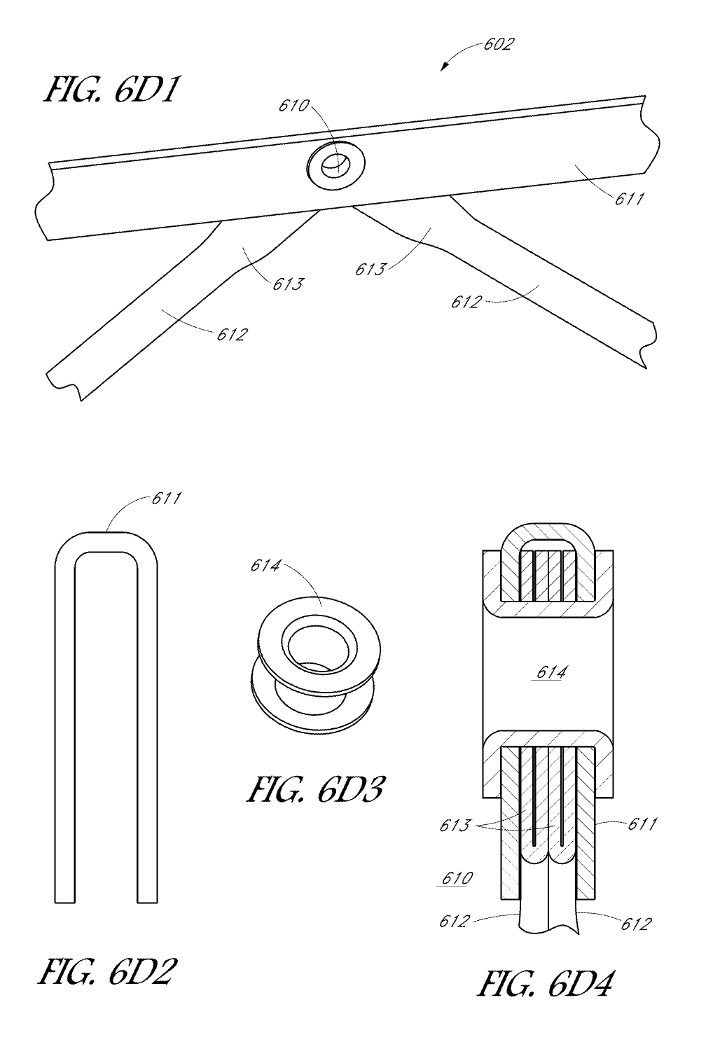

FIG. 7 shows end-on views of a litany of possible tracker stowage configurations that may be useful in this regard. In some of these configurations the edge trackers are horizontal and internal trackers are inclined. In other configurations the edge trackers are inclined and some of the internal trackers may be inclined.

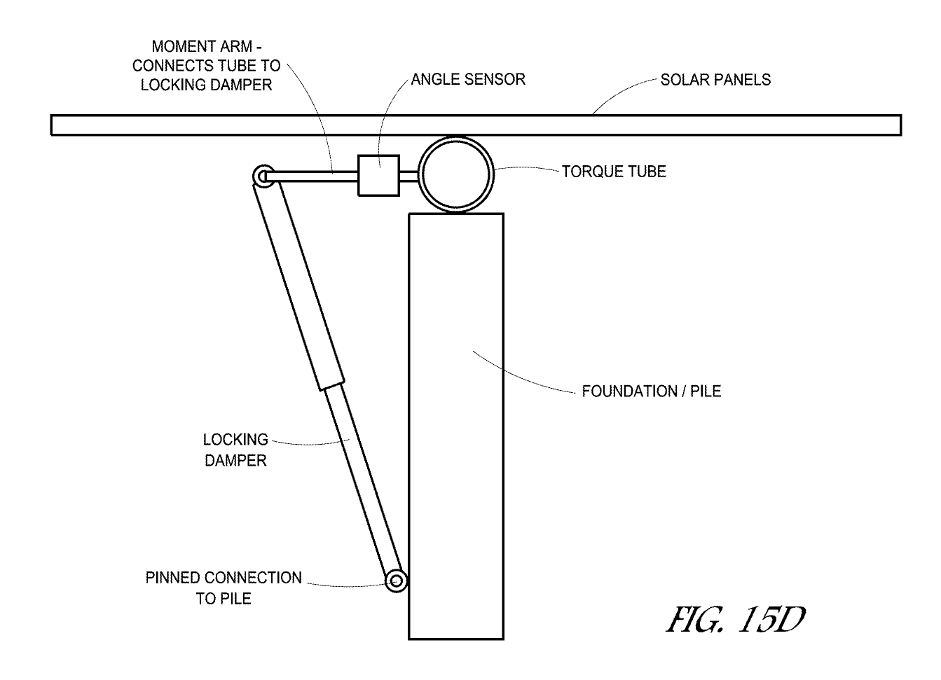

As indicated, above, it may be desirable to lock the panel in place against torsional forces such as wind (e.g., for stowing purposes). Accordingly, FIGS. 11A-11C show views of an embodiment in which a tracker 1100 comprises a torsional locking device comprising a locking damper 1110.

The damper normally can move back and forth (extend or retract) at a rate that will vary with the size of an orifice between two fluid chambers containing an incompressible fluid. If that orifice is closed, the incompressible fluid will stop a piston from moving in a hydraulic cylinder, in which case the damper is a fixed member.

FIGS. 11A-11B show the configuration under normal tracking operation. The damper acts as a shock absorber or damper during operation. It retracts and extends with the system.

FIG. 11C shows a high wind stow position. A valve is closed and fluid is stopped from moving in the damper. It is now torsionally locked and all forces are transferred to the pile.

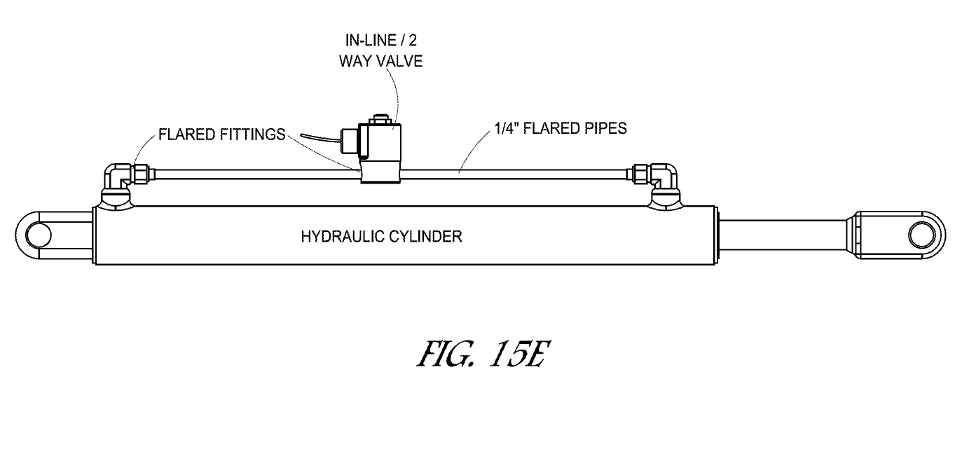

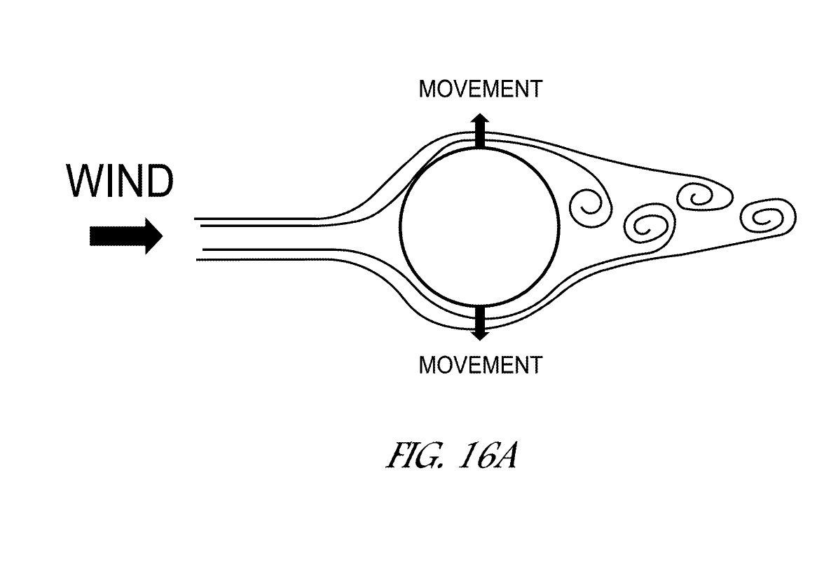

FIGS. 12A-12C show views of an alternative embodiment in which a tracker 1200 utilizes dampers as a torsional locking device. FIGS. 12A-12B show the configuration under normal tracking operation. FIG. 12C shows a high wind stow position.

In this design the torsional locking device comprises two dampers 1210A and 1210B, located one on each side of a support pile. As a result, the forces through each of the dampers will be smaller, allowing the cylinder design for the dampers to be lower cost. The vertical component of the force will get canceled out, which can reduce the cost of other components.

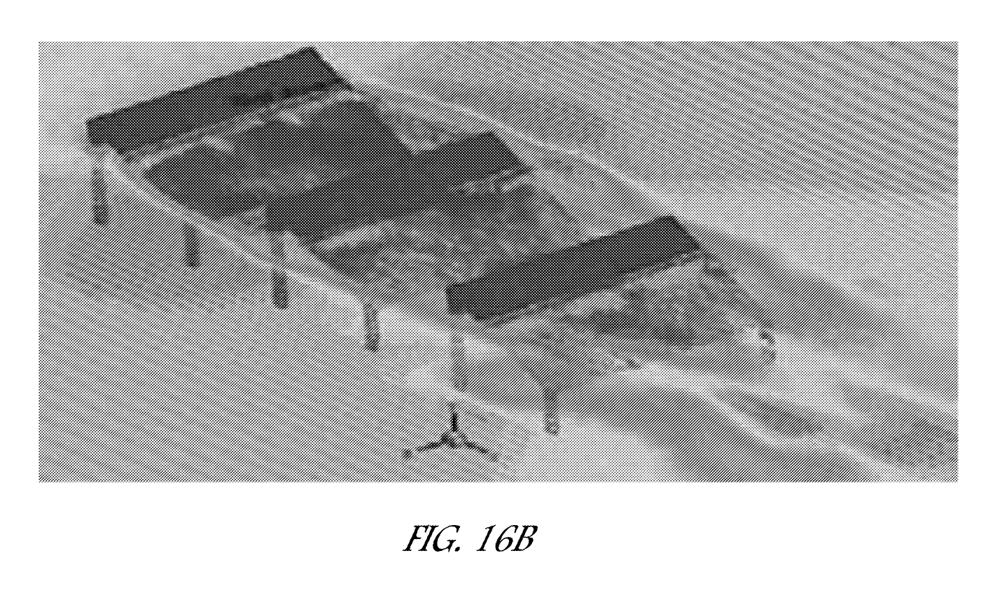

FIG. 13A shows an alternative embodiment in which a tracker 1300 utilizes two dampers 1310A and 1310B as a torsional locking device. Here, one valve 1315 can be used to close both cylinders. This reduces cost and increases reliability.

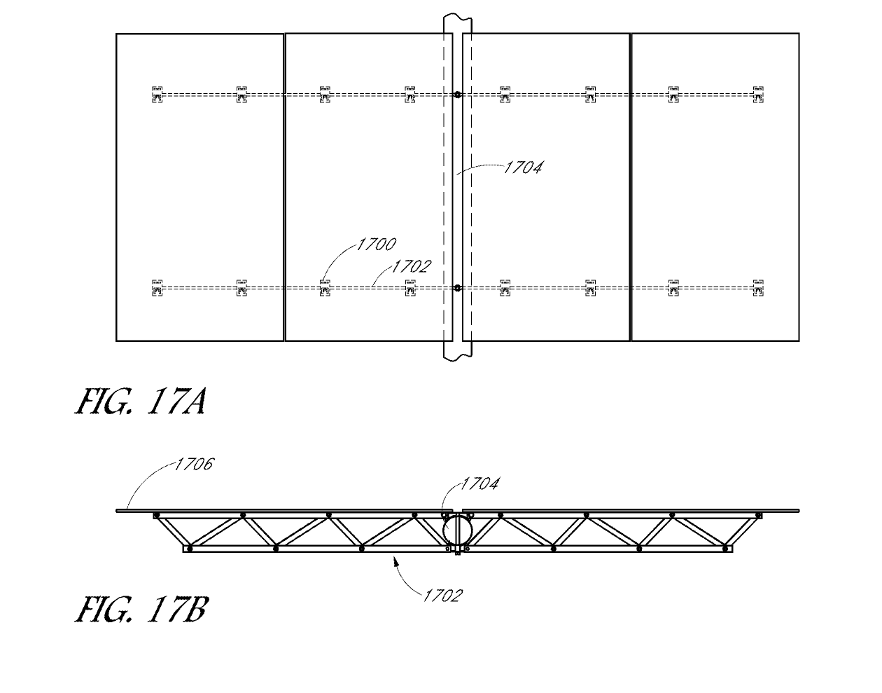

FIGS. 14A-C show views of an alternative embodiment in which a tracker 1400 utilizes a torsional locking device comprising a driven pin and a corresponding mating hole in a fixed location along the torque tube 1410 into which the pin may be engaged. When the tracker is moving, the pin is disengaged from the mating hole, as indicated by the downward arrow in FIGS. 14A-14B. When the tracker moves into stow position, a controller sends a command that pushes the pin into the mating hole. Now, all torsional forces are transferred directly into the pile 1415.

FIGS. 14A-14B show the configuration under normal tracking operation. With the pin removed from tube, the tracker can turn normally.

FIG. 14C shows a high wind stow position. The pin is driven up into tube. The tube is torsionally locked and forces are transferred to the pile.

FIG. 14D shows an enlarged view. A reinforced bracket spreads the load to the tube wall. The system will turn into position and the pin will move up into the hole.

FIGS. 15A-15C show views of an alternative embodiment in which a tracker 1500 utilizes a torsional locking device comprising a swinging arm 1510. Arm 1510 is rigidly fixed to the torque tube 1515. It rotates when the lock is not engaged and the system is tracking. When the tracker is moved to stow position, a locking feature can engage with the arm to fix the arm and the pile together. The system is not locked.

FIGS. 15A-B show the configuration under normal tracking operation. Locking arm 1510 is fixed to the torque tube and free to swing back and forth.

FIG. 15C shows a high wind stow position. The locking arm is moved into position and the tube is torsionally locked in place. Forces are transferred to the pile.

FIG. 15D shows an embodiment of a torsional locking mechanism utilizing a swinging arm in combination with a damper. FIG. 15E shows a detailed view of a damper according to an embodiment.

Torsional locking achieved according to embodiments may operate according to one or more of the following principles. When the wind is blowing, a pitching moment is collected along the length of the tube and adds up to a maximum torque at the driving mechanism.

This torque can be very high. The pitching moment increases by the width squared and by the wind speed squared. For a wide tracker, these loads will define the structure. The driving mechanism, the piles underneath the driving mechanism and the torque tube need to withstand the torque along the entire length.

A reason for this is that the other posts are designed with a low friction bearing that does not allow the moment to be transferred between the torque tube and the pile.

Embodiments address this issue by rigidly locking the tube to the piles when the tracker is in stow position. This can be done in a number of ways, several of which are outlined above.

One method (locking dampers) utilizes dampers—which are already installed on the tracker—to double as the lock. A second method (driven pin) adds a new assembly of parts to the design that will insert a locking pin into the tube at a bearing post. A third method (swinging arm) adds a new assembly of parts to the design that, when in stow position, will swing into a locking feature on the pile. Combinations of these approaches are possible.

The lock(s) can be placed at any number of piles. Embodiments may have all piles locked in high wind load zones of the field and only one or two locked in low wind zones of the field. This allows for a single tube, pile and driving mechanism design to be used throughout the field while still meeting all strength requirements.

Information from the locking mechanism can be collected and analyzed. FIG. 13B shows an embodiment featuring a damper deployed with an inclinometer that is tied to the angle of the tube. The controller can monitor the angle of the tracker at the locking pile.

When the tracker is moved to stow and not locked, the panels could be fluttering in the wind due to dynamic wind loads. The controller can use data from the angle sensor to lock the tracker at the ideal stow angle to reduce load.

The controller can also sense if there is a failure in the locking damper. If the lock is engaged and the angle keeps changing, then the lock is broken and needs to be serviced. If the lock remains engaged when the tracker is trying to move, then the controller can automatically stop the motor from breaking the tracker.

Torsional locking approaches according to various embodiments may offer one or more benefits. Without locking bearing posts, the torque adds up to one point. This increases the strength required for all the effected components, elevating cost.

However, by locking a bearing post, the total load is distributed between the driving mechanism and the lock. Those features can now be designed with lower strength requirements (which translates to a lower cost).

Also, when the tracker is positioned at or around horizontal, the entire length may twist in the wind. The pitching moment that the modules experience is maximum when they are around 15°. The ends of the tracker may experience the highest loads, because as the tube is twisting those modules feel a higher pitching moment.

However, by locking at one or more bearing posts, the tube will not twist as far (at the cantilever end and between locks). Therefore, the modules will not see as large of an increased pitching moment. Parts can be designed at a lower cost.

One of the limiting factors to the length of the tracker is that the driving mechanism cannot withstand the torque of the full tracker length. However, when the tracker is locked at some posts, the driving mechanism will only experience a limited portion of the total torque. Thus the design can become longer, adding a lock as needed to keep the maximum torque below a certain value. Eventually the length of the tracker is limited by other factors.

The effect of dynamically changing wind loads on the tracker can be very large. This is shown by the moments in the cross-sectional view of FIG. 16A.

Wind load forces can be caused by changing wind directions/intensities and turbulence caused by surrounding objects or other trackers. This is shown in the view of FIG. 16B.

By torsionally fixing the tube at some location along the length, the tube is broken up into shorter lengths. As the length becomes shorter, the natural frequency of the tube will be higher.

Dynamic amplification from wind is minimized on structures with higher natural frequencies. Thus there will be less amplification of the load because the tube has a higher natural frequency at this shorter length. Accordingly, the cost of the tube can be lower.

With a shorter length, the twist of the tube is smaller between fixed locations and at the cantilever end. This keeps the tube from twisting into the larger angles where it can experience increased loads. When not locked, the tube could twist closer to 15 degrees. The increased force from the wind at this angle could continue to increase the twist in the tube until the tracker eventually cannot withstand it and breaks.

Because the tube is not twisting so far due to dynamic wind loads, all the other components of the tracker (arms, modules, etc.) do not need to be designed as strong. Accordingly, lower cost is afforded.

Without locking devices, all the components for a large width tracker need to be stronger and heavier. By incorporating a locking functionality, they can become smaller and lighter. Not only does this reduce material costs, but it makes the structure easier to manufacture, ship and assemble. These factors also reduce cost.

A solar field can have fairly irregular shapes. The field designer can now use the locks to ensure that trackers fit into those irregular shapes, and can still withstand the potentially higher loads they will experience.

A designer may specify that a lock be put in at a special location. This will allow more flexibility in a field design. Ultimately this will result in higher power production.

For the locking damper design, the dampers are already in place to reduce the dynamic loads during regular operation. This design specifically utilizes these components to perform a second function while the tracker is no longer in operation. This helps reduce the cost of the overall design.

A damper could be designed to lock when the system is not tracking, and to unlock while the tracker is turning. This allows for the tracker to be rigidly fixed for most of the time. This will reduce the effects of dynamic loads and can lower cost.

The damper could also be used to control how the structure responds to dynamic wind loads. In some wind conditions, the tube could twist back and forth uncontrollably. This behavior depends on the stiffness of the structure and the location of the fixed points. The tracker could be designed to monitor the angle of the twist and then lock or unlock the dampers at precise moments in order to vary the stiffness. This could help ensure the structure survives high wind loads while still keeping a low part cost.

Embodiments of torsional locking mechanisms are not limited to those specifically illustrated, and variations are possible. For example, the locking damper design could have one damper per pile, two dampers per pile, or more than two dampers per pile. The dampers could be locked individually or simultaneously. If the locking device includes two dampers per pile, they may be attached to opposite sides of the tube, for example.

The size of an orifice in a damper may be fixed or variable. A variable orifice size may be used to control twisting motions of the tube.

The lock does not also need to be a damper. The two devices could be separate parts.

The locking device could also be used to actuate the tracker. For example, the locking device may be connected to a hydraulic pump and used to actuate the tracker as well as to lock the tracker in position when desired. In such variations the locking/actuating device (e.g., hydraulic pump actuator) may optionally replace the slew drive.

Any moment arm length and location for the damper can be used. The damper can be attached to anywhere on the pile or to the ground.

Field Layout Design

When a solar tracker product is tested in a wind tunnel, the resulting report can provide coefficients useful in determining wind pressures a tracker will encounter. The results can be broken into various categories based on the magnitude of the wind loads the tracker will be exposed to. The total forces on the rows from wind will be based on the area of solar panels and their location in the array. In particular, the forces and torque that the torque tube and driving mechanism will be influenced by the size and location of the row.

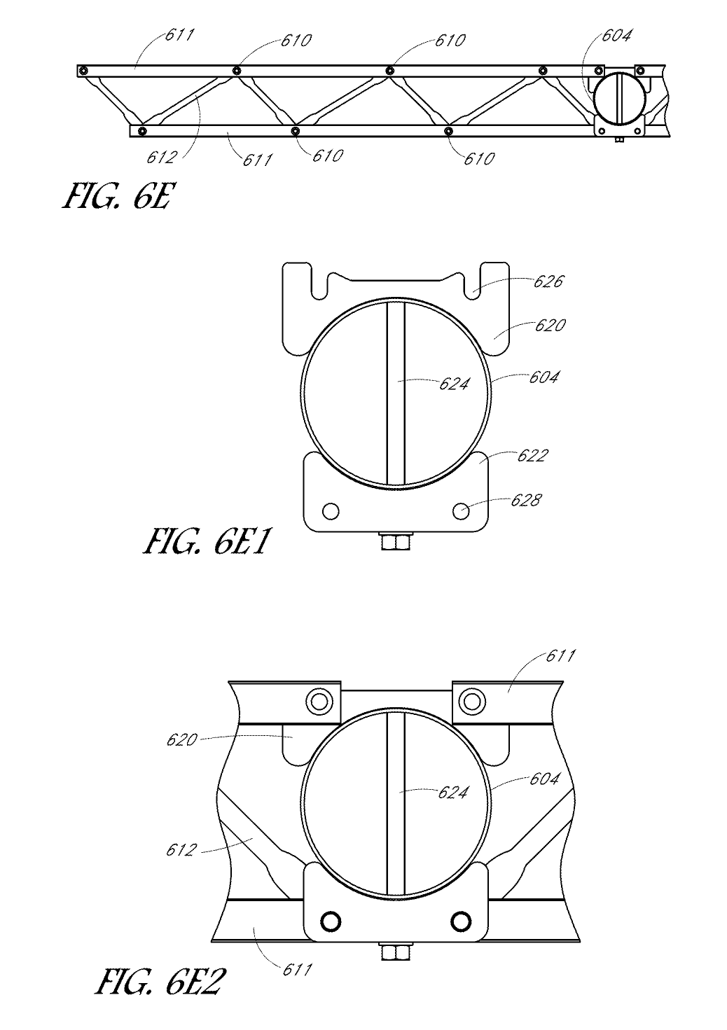

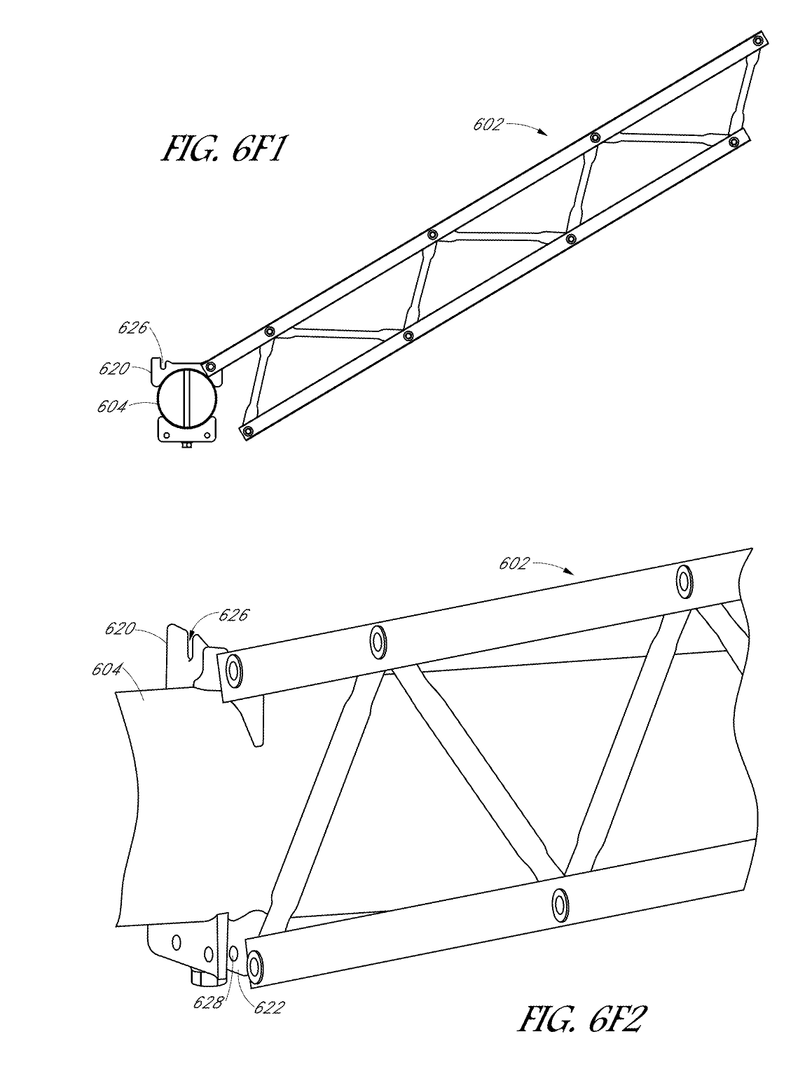

FIG. 8A shows one example. Here, the 1st edge rows (the two outer rows) will experience the highest wind loads. The 2^{nd} edge row sections, which may each include one or more rows, will see reduced wind loads compared to the 1^{st} edge rows because they are partially sheltered by the 1^{st} edge rows. The one or more rows of the interior row section will see the smallest wind loads because they are the most sheltered. If all the trackers are designed to be the same length and width, then the trackers in the interior rows will experience lower forces than those in the 1^{st} and 2^{nd} edge rows. If all of the trackers are built using the same components, then the interior rows will be overdesigned, adding significant cost.

Thus according to some embodiments, the trackers of the interior rows can be designed to their required strength and the trackers of the outer rows (e.g., the 1^{st} row sections) can be of essentially the same design and use the same parts, except for being shorter than the trackers of interior rows. The length of a tracker in the outer rows can be, for example, any fraction (e.g., ½) of the length of a tracker in the interior rows. So in the particular field design shown in the embodiment of FIG. 8B, the outer rows each have two trackers (rather than a single tracker as in the other rows), thereby drastically reducing the total load experienced by the torque tube, the driving mechanism, and the piles supporting the driving mechanism for each tracker in the outer rows compared to the case for a full length tracker in an outer row. This in turn allows the trackers of the inner rows to be designed with far less material—offering a significant reduction in cost. Moreover logistical costs should not significantly increase, since the same parts and tooling are used.

An additional embodiment could include a standard length for interior rows, some fraction of that length in the 2^{nd} edges rows and a further small fraction in the 1^{st} edge rows. This could afford for an even larger cost reduction.

This disclosure is illustrative and not limiting. Further modifications will be apparent to one skilled in the art in light of this disclosure and are intended to fall within the scope of the appended claims. For example, while various embodiments have been described in connection with single-axis solar trackers, one or more of the techniques described herein may be utilized in a solar tracker that is rotatable about multiple axes. Also, while embodiments have been described in connection with solar trackers comprising photovoltaic (PV) panels, other types of solar collectors (such as those based on thermal principles) could be tracked to the sun's movement utilizing principles as disclosed herein.

Various embodiments are described in the following clauses.

1. An apparatus comprising:

a torque tube;

a solar panel mounted on the torque tube;

a first plurality of piles arranged in line directly beneath the long axis of the torque tube and rotatably supporting the torque tube for rotation about its long axis;

a drive mechanism configured to rotate the torque tube about its long axis to track the sun; and

a foundation configured to support the drive mechanism, the foundation comprising at least two piles offset from the rotation axis, and one or more rigid member or assembly connecting the at least two piles and the drive mechanism.

2. An apparatus as in clause 1, comprising a support arm truss extending perpendicularly from the torque tube to support the solar panel.

3. An apparatus as in clause 2, comprising an attachment feature fixed to a bottom of the solar panel and secured to a node of the support arm truss.

4. An apparatus as in clause 3, wherein the node comprises a grommet.

5. An apparatus as in clause 4, wherein the attachment feature comprises a slide moveable into the grommet to secure the attachment feature to the support arm truss.

6. An apparatus as in clause 5, wherein the attachment feature comprises a ratchet mechanism locking the slide in place after it is moved into the grommet.

7. An apparatus as in any of clauses 2-6, wherein the support arm truss is attached to a mount secured by a bolt through a hole in the torque tube.

8. An apparatus as in any of clauses 2-7, wherein the support arm truss extends two meters or more perpendicularly from the torque tube.

9. An apparatus as in any of clauses 2-8, wherein all of the piles are of the same or substantially the same design and dimensions.

10. An apparatus as in any of clauses 2-9, wherein all of the piles are steel beams cast in concrete pads or driven piles.

11. An apparatus as in any of clauses 1-10, wherein the foundation supporting the drive mechanism comprises two piles offset from the rotation axis on opposite sides of the torque tube.

12. An apparatus comprising:

a torque tube;

a solar panel mounted on the torque tube;

a drive mechanism configured to rotate the torque tube about its long axis to track the sun;

an attachment feature on a back side of the solar panel; and

a support structure affixing the solar panel to the torque tube and comprising a support arm truss extending perpendicularly from the torque tube to support the solar panel;

wherein a node of the support arm truss is in contact with and engaged by the attachment feature.

13. An apparatus as in clause 12, wherein the attachment feature comprises a pawl block and a slide moveable within the pawl block to engage the node in the support arm truss.

14. An apparatus as in clause 13, wherein the node comprises a grommet receiving the slide.

15. An apparatus as in clause 12, wherein the support arm truss is attached to a mount secured by a bolt through a hole in the torque tube.

16. An apparatus as in clause 15, wherein the support arm truss is attached by pivoting about a slot in the mount.

17. An apparatus as in any of clauses 12-16, wherein the attachment feature comprises a ratchet mechanism locking the attachment feature to the node of the support arm truss.

18. An apparatus as in any of clauses 12-17, wherein the support arm truss extends two meters or more perpendicularly from the torque tube.

19. A method comprising;

attaching a support arm truss to a torque tube to extend perpendicularly from the torque tube;

lowering a solar panel onto the support arm truss; and

causing an attachment feature attached to the bottom of the solar panel to engage a node of the support arm truss and thereby secure the solar panel to the support arm truss.

20. A method as in clause 19, comprising moving a sliding portion of the attachment feature into an opening in the node.

21. A method as in clause 20, comprising locking the sliding feature in place in the opening with a ratchet mechanism.

22. A method as in clause 20 or clause 21, wherein the opening is defined by a grommet attaching two or more truss members to each other at the node.

23. A method as in any of clauses 19-22, comprising attaching the attachment feature to the solar panel with glue.

24. A method comprising:

providing an array of single-axis solar collectors comprising an outside row rotatable about a first axis and an inside row rotatable about a second axis parallel to the first axis; and

stowing the array against wind forces by rotating the outer row to a first angle, and rotating the inner row to a second angle different from the first angle.

25. A method as in clause 24 wherein the first angle is substantially horizontal and the second angle is not substantially horizontal.

26. A method as in clause 24 wherein the first angle is not substantially horizontal and the second angle is opposite to the first angle.

27. A method as in clause 24 wherein the first angle is not substantially horizontal, the second angle is not substantially horizontal, and the first and second angles are different.

28. An array of single axis solar trackers arranged with their rotation axes parallel in a plurality of side-by-side rows, the array comprising:

a first inside row comprising a number N_{FIRST INSIDE} of the solar trackers each having a length L_{FIRST INSIDE} and arranged in line; and

an outside row comprising a number N_{OUTSIDE} of the solar trackers each having a length L_{OUTSIDE}<L_{FIRST INSIDE} and arranged in line;

wherein all of the solar trackers in the first inside row and the outside row have the same or substantially the same widths perpendicular to their rotation axes, are of the same or substantially the same design except for differences in length, and utilize the same or substantially the same component set.

29. An array of single axis solar trackers as in clause 28, wherein the first inside row and the outside row are of the same or substantially the same length, and N_{OUTSIDE}>N_{FIRST INSIDE}.

30. An array of single axis solar trackers as in clause 28, wherein a total light collecting area of the solar trackers in the first inside row is the same or substantially the same as a total light collecting area of the solar trackers in the outside row, and N_{OUTSIDE}>N_{FIRST INSIDE}.

31. An array of single axis solar trackers as in clause 28, comprising a second inside row located on the opposite side of the first inside row from the outside row, wherein:

the second inside row comprises a number N_{SECOND INSIDE} of the solar trackers each having a length L_{SECOND INSIDE} and arranged in a line;

L_{SECOND INSIDE}>L_{FIRST INSIDE}; and

all of the solar trackers in the first inside row, the second inside row, and the outside row have the same or substantially the same widths perpendicular to their rotation axes, are of the same or substantially the same design except for differences in length, and utilize the same or substantially the same component set.

32. An array of single axis solar trackers as in clause 31, wherein the first inside row, the second inside row, and the outside row are of the same or substantially the same length, and N_{OUTSIDE}>N_{FIRST INSIDE}>N_{SECOND INSIDE}.

33. An array of single axis solar trackers as in claim 31, wherein a total light collecting area of the solar trackers in the first inside row, a total light collecting area of the solar trackers in the second inside row, and a total light collecting area of the solar trackers in the outside row is the same or substantially the same and N_{OUTSIDE}>N_{FIRST INSIDE}>N_{SECOND INSIDE}.

What is claimed is:

1. An apparatus comprising:
a torque tube;
a solar panel attached to the torque tube;
a first plurality of piles arranged in line directly beneath the long axis of the torque tube and rotatably supporting the torque tube for rotation about its long axis;
a drive mechanism configured to rotate the torque tube about its long axis to track the sun, a curved surface of the drive mechanism accommodating torque tube alignment; and
a foundation configured to support the drive mechanism, the foundation comprising at least two piles offset from the rotation axis, and one or more rigid member or assembly connecting the at least two piles and the drive mechanism.

2. An apparatus as in claim 1 further comprising a first curved surface on the one or more rigid member or assembly complementary in shape to the curved surface of the drive mechanism and on which the curved surface of the drive mechanism is seated.

3. An apparatus as in claim 2, wherein the curved surface of the drive mechanism is convex and the first curved surface of the rigid member or assembly is concave.

4. An apparatus as in claim 2, wherein the curved surface of the drive mechanism is concave and the first curved surface of the rigid member or assembly is convex.

5. An apparatus as in claim 2, comprising a second curved surface on the one or more rigid member or assembly located on an opposite side of the rigid member or assembly from the first curved surface, a securing ring or plate having a curved surface complementary in shape to and seated on the second curved surface of the rigid member or assembly, and one or more fasteners passing through holes in the securing ring or plate and through holes in the rigid member or assembly to secure the drive mechanism to the rigid member or assembly.

6. An apparatus as in claim 5 wherein the second curved surface of the rigid member or assembly is convex and the curved surface of the securing ring or plate is concave.

7. An apparatus as in claim 5, wherein the second curved surface of the rigid member or assembly is concave and the curved surface of the securing ring or plate is convex.

8. An apparatus as in claim 5, wherein the curved surface of the drive mechanism is convex and the first curved surface of the rigid member or assembly is concave.

9. An apparatus as in claim 8, wherein the second curved surface of the rigid member or assembly is convex and the curved surface of the securing ring or plate is concave.

10. An apparatus as in claim 8, wherein the second curved surface of the rigid member or assembly is concave and the curved surface of the securing ring or plate is convex.

11. An apparatus as in claim 5, wherein the curved surface of the drive mechanism is concave and the first curved surface of the rigid member or assembly is convex.

12. An apparatus as in claim 11, wherein the second curved surface of the rigid member or assembly is convex and the curved surface of the securing ring or plate is concave.

13. An apparatus as in claim 11, wherein the second curved surface of the rigid member or assembly is concave and the curved surface of the securing ring or plate is convex.

14. An apparatus as in claim 1, comprising a support arm truss extending perpendicularly from the torque tube to support the solar panel.

15. An apparatus as in claim 1, wherein all of the piles are of the same or substantially the same design and dimensions.

16. An apparatus as in claim 1, wherein all of the piles are steel beams cast in concrete pads or driven piles.

17. An apparatus as in claim 1, wherein the foundation supporting the drive mechanism comprises two piles offset from the rotation axis on opposite sides of the torque tube.

18. An apparatus as in claim 1 comprising:
an attachment feature on a back side of the solar panel; and
a support structure affixing the solar panel to the torque tube and comprising a support arm truss extending perpendicularly from the torque tube to support the solar panel;
wherein a node of the support arm truss is in contact with and engaged by the attachment feature utilizing a slide including a pin.

19. An apparatus as in claim 18, wherein the node comprises a grommet receiving the slide.

20. An apparatus as in claim 18 wherein the pin includes:
a first notch engageable to secure the pin in a first position during shipping; and
a second notch engageable to secure the pin in a second position within the node following installation.
